(19) United States
(12) Patent Application Publication
(10) Pub. No.: US 2024/0050885 A1
(43) Pub. Date: Feb. 15, 2024

(54) STRUCTURES AND METHODS FOR ENHANCING CAPTURE OF CARBON DIOXIDE FROM AMBIENT AIR

(71) Applicant: W. L. Gore & Associates, Inc., Newark, DE (US)

(72) Inventors: Edward H. Cully, Newark, DE (US); Christine M. Scotti, Newark, DE (US)

(21) Appl. No.: 18/234,014

(22) Filed: Aug. 15, 2023

Related U.S. Application Data
(60) Provisional application No. 63/532,584, filed on Aug. 14, 2023.
(60) Provisional application No. 63/397,977, filed on Aug. 15, 2022.

(51) Int. Cl. B01D 53/04; B01J 20/28

(52) U.S. Cl. CPC B01D 53/0407; B01D 53/0462; B01J 20/28035; B01J 20/28038; B01D 2257/504; B01D 2259/40077; B01D 2259/4009; B01D 2259/4558; B01D 2253/25; B01D 2253/34; B01D 2259/40035; B01D 2259/40043; B01D 2259/40062; B01D 2259/40028; B01D 2258/0283; B01D 2253/304; B01D 2259/40009

(57) ABSTRACT

An improved DAC unit and process containing an adsorber structure comprising an array of adsorber elements with a support layer and on both sides thereof at least one sorbent layer and at least one protective layer comprising a microporous material disposed around the support layer and the sorbent layer, wherein the protective layer has greater hydrophobicity than the sorbent material, wherein the adsorber elements are parallel to each other and spaced apart forming parallel fluid passages for flow-through of ambient atmospheric air and/or desorbing media, the method comprising the following sequential and repeating steps: (a) adsorption by flow-through; (b) isolating said sorbent; (c) injecting a stream of desorbing media through said parallel fluid passages and inducing an increase of the temperature; (d) extracting desorbed carbon dioxide from the unit and separating it from desorbing media; (e) bringing the sorbent material to ambient temperature conditions.

### CROSS REFERENCE TO RELATED APPLICATIONS

This application claims the benefit of U.S. Provisional Application No. 63/397,977, filed Aug. 15, 2022, and U.S. Provisional Application No. 63/532,584, filed Aug. 14, 2023, the disclosures of which are incorporated herein by reference in their entireties for all purposes.

### FIELD

The present disclosure relates to a method for the adsorption and desorption of a sorbent used in cyclical adsorption-desorption for the capture of carbon dioxide, CO₂, directly from ambient atmospheric air or highly dilute sources, as well as to uses of such a method and devices for such a method. The present disclosure further relates to an optimized configuration of an adsorber structure with a multitude of parallel surfaces for the efficient capture of carbon dioxide from ambient air as well as uses thereof.

### BACKGROUND

Gas separation by adsorption/desorption processes, more specifically the capture of carbon dioxide from atmospheric air, which is known as direct air capture (DAC), is a field of growing importance as a potential measure aimed at reducing the impact of greenhouse gases. The conditioning of atmospheric air and CO₂ during adsorption is generally not a feasible option energetically at the prevalent CO₂ concentrations and adsorption conditions; however, the conditions under which contact with the sorbent material occurs can be influenced by the configuration of the adsorber structure. Furthermore, the conditions that lead to desorption of CO₂ from the sorbent are significantly more varied and complex—and these are generally based on the broad knowledge base on other industries in the gas separation field. Widely established capture of CO₂ from flue gases can generally rely solely on a substantial change in CO₂ partial pressure or system temperature to initiate a release of CO₂ by the sorbent. DAC working with lower CO₂ concentrations must however combine various measures of shifting the sorbent CO₂ uptake equilibrium to achieve economically attractive working capacities. Therefore, newer methods specifically for the purpose of desorption in direct air capture processes have emerged and continue to emerge, along with adsorber structure innovations.

Generally, flue gas CO₂ separation processes aim for mostly complete removal of CO₂ from the flue gas, with capture fractions larger than 80%. Therefore, configurations maximize contact with the sorbent and gas stream with pressure drop and pumping work being of secondary concern. Typical configurations include packed bed columns or fluidized beds with typical lengths of several ten centimeters to several meters, which typically impose pressure drops of several thousand Pascal up to several bars on the gas flow. More recently, structured adsorbers have also been employed for capturing CO₂ from flue gas, such as the structures described by WO-A-2010096916 (Boulet et al) and WO-A-2018085927 (Inventys Thermal Technologies Inc.), that specify parallel passage contactors for the purpose of flue gas CO₂ capture. These adsorber structures in their configuration for flue gas capture are designed for the high concentrations of CO₂ present in flue gas and operate with the aim of capturing a high fraction of CO₂ from the flue gas.

More specifically, WO-A-2018085927 discloses an adsorptive gas separation apparatus and method. The adsorbent structure may include a first adsorbent layer having at least a first adsorbent material, a second adsorbent layer including at least a second adsorbent material, and a barrier layer, where the barrier layer is interposed between the first adsorbent layer and the second adsorbent layer. A parallel passage contactor including a plurality of adsorbent structures each comprising a barrier layer, and arranged to form first and second fluid passages is also disclosed. An adsorption process for separating at least a first component from a multi-component fluid stream using the adsorbent structure is also provided.

US-A-2015139862 (L'Air Liquide Societe Anonyme pour ('Etude et l'Exploitation des Procedes Georges Claude) discloses a structured adsorbent sheet, including a nano-adsorbent powder, and a binder material, wherein the nano-adsorbent powder is combined with the binder material to form an adsorbent material, and a porous electrical heating substrate, wherein the adsorbent material is applied to the porous electrical heating substrate thereby forming a structured adsorbent sheet. A structured adsorbent module is provided, including a plurality of stacked structured adsorbent sheets, configured to produce a plurality of fluid passages, wherein the plurality of fluid passages have a cross-sectional shape in the direction of a fluid stream. The structured adsorbent module may have a cross-sectional shape that is trapezoidal, rectangle, square, triangular or sinusoidal. A structured adsorbent bed is provided, including a plurality of modules, stacking the modules, thereby providing a plurality of process fluid passages, and a process fluid inlet and a process fluid outlet, in fluid communication with the plurality of process fluid.

US-A-2012076711 (ETH ZURICH) discloses a structure containing a sorbent with amine groups that is capable of a reversible adsorption and desorption cycle for capturing CO₂ from a gas mixture wherein said structure is composed of fiber filaments wherein the fiber material is carbon and/or polyacrylonitrile.

However, the low ambient concentration of CO₂ in direct air capture means that much larger volumes of air need to be moved through the adsorber structure at ambient conditions, and thus flue gas capture configurations cannot be used due to the high pressure-drop across them. Therefore, for direct air capture CO₂ separation processes, configurations of the sorbent material are desired, which impose as little pressure drop on the air flow as necessary, in order to minimize the energy required for adsorption gas pumping, but at the same time achieve maximum contact between the sorbent and the gas stream in order to maximize the mass transfer rates of the components to be removed from the gas stream. These structures are very different from those required for flue gas capture. Such a structure for DAC is e.g. disclosed in WO-A-2014170184 (Climeworks AG).

Various capture methods have recently been disclosed using adsorber structures specifically configured to direct air capture. One common approach is based on a cyclic adsorption/desorption process on solid, chemically functionalized sorbent materials. For example, US-A-2011041688 (Eisenberger) discloses carbon dioxide capture/regeneration structures and techniques using a fluidized bed of coated granular material. Various wall flow structures for low pressure drop flow across a bed of granular adsorbents are disclosed in WO-A-2018083109 (Climeworks AG), WO-A-2018210617 (Climeworks AG). Other solutions opt to use structured adsorbers such as the monoliths used in US-A-2014004016 (Eisenberger et al), or liquid solutions distributed across a contactor device such as in WO-A-2009155539 (1446881 Alberta Ltd.) and WO-A-2010022339 (1446881 Alberta Ltd.). Packed bed granular contactors generally aim to distribute the flow and thus reduce the velocity and increase the residence time of the adsorptive air flow in the bed, in order to counter the generally longer diffusion paths and therefore slower kinetics of these structures, as WO-A-2018083109, WO-A-2018210617. In contrast, structured adsorbers, such as WO-A-2010027929 (Alstom Technology Ltd.), WO-A-2010151271 (Sri International), and sorbents supported on support matrices, such as WO-A-2009067625 (Global Research Technologies, LLC), exhibit shorter diffusion paths and the residence time can therefore be lower by an order of magnitude, resulting in higher direct through flow velocities.

Structured sorbents made of multi-layer sheets of adsorbing material have been investigated in a number of applications. An early example is provided in U.S. Pat. No. 4,234,326 (The Secretary of State for Defence in Her Britannic Majesty's Government of the United Kingdom of Great Britain and Northern Ireland) where construction of the parallel-flow filter consists of alternate layers of charcoal cloth and air permeable spacing. Further development of layered structured adsorbents for Hydrogen purification using rapid PSA is described in a number of patents. U.S. Pat. No. 5,082,473 (Keefer), U.S. Pat. No. 6,451,095 (QuestAir Technologies, Inc.), U.S. Pat. No. 6,692,626 (QuestAir Technologies, Inc.) describe equilibrium-controlled pressure swing adsorption (PSA) processes that may be enhanced by configuring the adsorbers as layered adsorbent laminate sheet parallel passage contactor structures, with the adsorbent material formed into adsorbent sheets, with or without suitable reinforcement materials incorporated into such sheets. Specific benefits for kinetic selectivity of these structures is discussed e.g. in detail in U.S. Pat. No. 7,645,324 (Xebec Adsorption Inc.) when including small pore sorbents into adsorbing sheets. An example of an air capture device including individual pairs of sheets forming a lamella designed to remove CO₂ from flow is provided in WO-A-200914292 (Korea Research Institute Of Chemical Technology et al).

Newer methods specifically for the purpose of desorption in direct air capture processes have provided energy to the sorbent by various other means, such as WO-A-2016005226 (Climeworks AG), WO-A-2014170184 (Climeworks AG), where the desorption methods combine temperature swings realized by use of heat exchangers with vacuum swings and steam purge gas flows. However—while conductive heating can be easily controlled, avoids near saturation instabilities (i.e. wet steam) and does not load sorbent materials with large amounts of liquid water —conductive heat transfer through typical granular beds of highly porous sorbents materials is commonly very poor. Furthermore, the heat exchangers displace sorbent material, thus considerably reducing output per unit volume. For structured adsorbers, such as monoliths, the integration of a heat exchanger is non-trivial and a challenge unto itself. Extensive heating and drying of the sorbent in this manner has also been shown to cause substantial degradation to the sorbent material, reducing CO₂ uptake capability and leading to an overall reduction in the sorbent operational lifetime. In combination with their high cost, such solutions are not necessarily economically feasible for the widespread application of DAC. Usage of steam for the regeneration of sorbents is not new, dating back several decades, such as indicated by GB-A-1296889 (Aaron et al) or DE-A-3030967 (Daimler Benz AG). However, in an attempt to overcome the aforementioned issues for purposes of direct air capture, pure steam desorption processes have received increased attention in this field in recent years, see US-A-2014096684 (Kawasaki Jukogyo Kabushiki Kaisha), US-A-2018214822 (Eisenberger), WO-A-2016038339 (Johnson Matthey Public Limited Company), US-A-2011088550 (Accucaps Industries Limited), WO-A-2014063046 (ADA-ES, Inc.), US-A-2011179948 (Choi et al), US-A-2015209718 (Eisenberger et al), EP-A-2874727 (Antecy BV), US-A-2007149398 (Jones et al), US-A-2014130670 (Eisenberger et al), U.S. Pat. No. 7,288,136 (United States of America Department of Energy, WO-A-2016037668 (Giaura BV), US-A-2018272266 (Shell Oil Company) or U.S. Pat. No. 8,500,854 (U.S. Department of Energy). These are generally reference steam processes from other industries where both saturated and superheated steam is used for the regeneration of sorbents. Steam desorption methods allow for fast and uniform heating of the sorbent, with the innate drawback of substantial deposition of water in the sorbent materials, where these considerable amounts of additional water may impede the continued successful cycling of the material for the purpose of CO₂-capture. The addition of water may reduce the transport kinetics in porous sorbent materials, or potentially wash out the active phase rendering the sorbent material inactive for further capture of CO₂. The key to effective operation is therefore the combination of a process and sorbent material that allows for cyclic operation of the direct air capture plant.

Devices for such a process have also been disclosed. Aside from introducing steam from an external source into the reaction chamber, previously disclosed devices for such a desorption technique disclose, for example, a steam generation reservoir inside the sorbent chamber (US-A-2014096684, WO-A-2016005226) or describe the reuse of steam within a limited number of reaction chambers (US-A-2013312606 (Eisenberger)).

The aspects relevant to cyclic operation include the conditions of adsorption, any preparation prior of the regeneration, the temperature and pressure level of regeneration as well as the conditions of the steam employed, and any post-regeneration steps. While some process-oriented disclosures describe a reduction of pressure or alternatively purge of air from within the reaction chamber (EP-A-2874727, WO-A-2016037668, US-A-2011296872 (Eisenberger)), most leave this unaddressed. The condition of the steam employed is, if further disclosed at all, saturated steam (US-A-2013312606, U.S. Pat. No. 7,288,136).

The sorbent temperature during regeneration is of particular importance, as many common CO₂ sorbent systems show a rapid reduction in cyclical CO₂ capture capacity due to degradation, primarily driven by the exposure to sufficiently high temperatures and oxidation by the exposure to oxygen at sufficiently high temperatures. On the other hand, higher temperatures, in most sorbents, facilitate faster desorption rates and higher CO₂ desorption amounts.

US-A-2018214822 proposes a method for removing carbon dioxide directly from ambient air, using a sorbent under ambient conditions, to obtain relatively pure CO₂. CO₂ is removed from the sorbent using process heat, preferably in the form of steam, at a temperature in the range of not greater than about 130° C., to capture the relatively pure CO₂ and to regenerate the sorbent for repeated use. Increased efficiency can be achieved by admixing with the ambient air, prior to contacting the sorbent, a minor amount of a preferably pretreated effluent gas containing a higher concentration of carbon dioxide. The captured carbon dioxide can be stored for further use, or sequestered permanently. The method provides purified carbon dioxide for further use in agriculture and chemical processes, or for permanent sequestration. The document only discloses flow speed values at the entrance opening of full sorbent structures but fails to disclose information about flow speed in the flow channels of sorbent structures.

### SUMMARY

The use of steam as a regeneration media has become popular, since steam is an effective method to transfer heat and may be found as a byproduct of other industrial processes or may be scavenged from geothermal sources. However, using liquid water has detrimental effects including reducing the transport kinetics in porous sorbent materials, or potentially washing out the active phase rendering the sorbent material inactive for further capture of CO₂, as disclosed in International Publication No. WO 2021/239747 filed by Climeworks AG (hereinafter “the '747 Climeworks publication”). Additionally, liquid water can block the pores of mesoporous structures in what is commonly known as “water-lock”. Water lock can lower kinetics of a sorbent to a point where it is economically unfeasible to continue operation. Furthermore, humid air contains water vapor and, when cooled below the current dewpoint, condenses into liquid water. Processes and environmental conditions may also expose the structured sorbents to liquid water. Although it is commonly acknowledged that liquid water can be detrimental to sorbent life and kinetics of the process, prior art has been silent on materials, or techniques to mitigate this issue.

In the present disclosure, materials, combinations of materials, and methods are provided to selectively allow water vapor (and heat) to access the sorbent. Beneficially, water vapor is allowed to evaporate in order to facilitate cooling, while simultaneously mitigating the detrimental effects of liquid water by minimizing and/or preventing the entry of liquid water into sorbent layers or sorbent bed of the device which facilitates adsorption and desorption. In some examples, as disclosed herein, such benefits may be accomplished through the use of thin and durable microporous membranes exhibiting a high degree of hydrophobicity. These materials may be configured as coverings, additional layers, or as interior channels, as further disclosed herein.

The disclosure of the '747 Climeworks publication relates to a method and a device for the adsorption and desorption of a sorbent used in cyclical adsorption-desorption for the capture of carbon dioxide, CO₂, directly from ambient atmospheric air, as well as to uses of such methods and devices. Two defining aspects of the method are the essentially exclusive use or fully exclusive use of steam for the delivery of heating energy during the desorption process, as well as the use of a parallel passage contactor, exemplified in WO-A-2010096916 and WO-A-2018085927, but with a configuration and sorbent preferably optimized for direct air capture. In order to allow for efficient and economic cyclic operation, a multitude of further requirements as detailed is preferably complied with.

In comparison, according to some examples of the present disclosure, the device for adsorption and desorption also includes at least one protective layer comprising a microporous material (which may be formed from any suitable material with high hydrophobicity) disposed around a support layer and a sorbent layer of the device of adsorption and desorption. The protective layer is hydrophobic and has a greater hydrophobicity than the sorbent material. In some examples, at least one support layer includes a plurality of lumens extending therethrough, and the stream of desorbing media (which in some examples may be one or more of: hot liquid, steam, saturated steam, superheated liquid, or any substance that transfers heat, etc.) is injected by flow-through through said lumens to start the desorption of CO₂. In some examples, the stream of desorbing media may be saturated or superheated prior to injection. In some examples, the stream of desorbing media is injected through the lumens in a direction substantially orthogonal or perpendicular to a direction in which the ambient atmospheric air flows through the parallel fluid passages. In some examples, the lumens are interconnected with each other. In some examples, the device also includes spacer elements, where the spacer elements comprise a sorbent material configured to facilitate adsorption and desorption through the spacer elements. The spacer elements increase a ratio of a sorbent mass (adsorptive mass) of the adsorber element to a total mass of the adsorber element. In some examples, the protective layer may also be disposed around the spacer elements to provide protection for the spacer elements from the surrounding or external elements.

Advantages of the aforementioned features of the present disclosure are provided herein. For example, the hydrophobic protective layer comprising the microporous material and the spacer elements comprising the sorbent material beneficially improve the adsorption and desorption process. Specifically, the hydrophobic protective layer controls the access of liquid water through the sorbent material, for example, by minimizing and/or preventing the entry of liquid water therein. The lumens allow the stream of desorbing media to flow through the support layer of the sorbent layers in addition to flowing around or passing by the external surfaces of these sorbent layers. In this regard, the lumens increase the proximity of the desorbing media to the adsorber element (e.g., the sorbent materials of the sorbent layers) to facilitate more a proactive adsorption/desorption process. The spacer elements provide additional volume or mass of sorbent material, in order to increase a ratio of a sorbent mass of the adsorber element to a total mass of the adsorber element, which beneficially improves the adsorptive and desorptive property of the device as a whole. The spacer elements may further beneficially increase a density of the sorbent article without changing an occupied volume of the adsorber structure.

Suitable and preferred sorbent layer materials for use in the method as disclosed in the '747 Climeworks publication to act as sorbents suitable and adapted or even optimized for direct air capture have a process cyclical CO₂ capacity in the range of 0.3 to 3 mmol/g and/or a water uptake of less than 70% of their own weight. They take the form of a solid material, which can be in the form of one or an assembly of contiguous layers/coatings or of particular nature (typically polymeric material), which is surface modified and/or porous to provide for carbon dioxide adsorption. The corresponding surface modification can be provided by impregnation, grafting and/or bonding of corresponding functionalities, in particular primary and/or secondary amine functionalities. The sorbent material can be an amine-functionalized solid adsorbent or X₂CO₃, wherein X is K, Na, Li or a mixture thereof, preferably impregnated onto a porous granular support, e.g. active carbon. For example, the material can be a weak-base ion exchange resin and/or amine-functionalized cellulose and/or amine-functionalized silica and/or amine-functionalized carbons and/or amine-functionalized metal organic frameworks and/or other amine-functionalized polymeric adsorbents. Another sorbent material suitable for use with the '747 Climeworks publication can be amine-functionalized cellulose as described in WO2012/168346 (Empa Eidgenössische Materialprüfungs-Und Forschungsanstalt). Such sorbents can contain different type of amino functionalization and polymers, such as immobilized aminosilane-based sorbents as reported in U.S. Pat. No. 8,834,822 (Georgia Tech Research Corporation et al) or materials according to WO-A-2011/049759 (Lanxess Sybron Chemicals, Inc.) describing an ion exchange material comprising an aminoalkylated bead polymer for the removal of carbon dioxide from industrial applications. Another possible sorbent is the one of WO-A-2016/037668 for reversibly adsorbing CO₂ from a gas mixture, here the sorbent is composed of a polymeric adsorbent having a primary amino functionality. The materials can also be of the type as disclosed in EP 20 186 310.7 (Climeworks AG, incorporated by reference). Also, they can be of the type as disclosed in EP 20 181 440.7 (Climeworks AG, incorporated by reference), so materials where a solid inorganic or organic, non-polymeric or polymeric support material is functionalized on the surface with amino functionalities capable of reversibly binding carbon dioxide, with a specific BET surface area, in the range of 1-20 m²/g. The solid inorganic or organic, non-polymeric or polymeric support material can be an organic or inorganic polymeric support, preferably an organic polymeric support, in particular a polystyrene based material, preferably a styrene divinylbenzene copolymer, preferably to form the sorbent material surface functionalized with primary amine, preferably methyl amine, most preferably benzylamine moieties, wherein the solid polymeric support material is preferably obtained in an emulsion polymerization process, or can be a non-polymeric inorganic support, preferably selected from the group consisting of: silica (SiO₂), alumina (Al₂O₃), titania (TiO₂), magnesia (MgO), clays, as well as mixed forms thereof, such as silica-alumina (SiO₂—Al₂O₃), or mixtures thereof.

The sorbent material of the '747 Climeworks publication generally, and/or in the above case the solid inorganic or organic, non-polymeric or polymeric support material, can be in the form of at least one of monolith, layer or sheet, hollow or solid fibers, preferably in woven or nonwoven structures, hollow or solid particles, or extrudates, wherein preferably it takes the form of preferably essentially spherical beads with a particle size (D50) in the range of 0.01-1.5 m, preferably in the range of 0.30-1.25 mm, or the solid inorganic or organic, non-polymeric or polymeric support material is in the form of solid particles embedded in a porous or non-porous matrix. Preferred sorbent layer materials at the end of step (a) show a carbon dioxide loading in the range of 0.3-4 mmol/g, preferably in the range of 0.5-3.5 mmol/g, and/or they have a cyclic carbon dioxide capacity in the range of 0.1-3.5 mmol/g, preferably in the range of 0.3-3 mmol/g. Furthermore they preferably have a carbon dioxide uptake rate in the range of 0.5-10 mmol/g/h, preferably in the range of 1-6 mmol/g/h, preferably taken as the average over a time span of 5-10 mins. Further preferably, they have a water uptake of less than 70% by weight, preferably of less than 50% by weight.

Preferred support layers in the '747 Climeworks publication are based on metal, polymer, carbon, carbon molecular sieve and graphene material layers or layers based on combinations of these materials.

The adsorber structure as used in the method proposed in the '747 Climeworks publication comprises a multitude of adsorber elements arranged in an array. Each adsorber element is a composite of a porous support layer or sheet and at least one sorbent layer attached to said porous support such that it is accessible from both sides of the adsorber element. The sorbent layer comprises or consists of at least one sorbent material, offering selective adsorption of CO₂ over other major non-condensable gases in air in the presence of moisture. In an alternate embodiment, the adsorber element comprises a carrier or support layer, with a first and second sorbent layer attached on either side of said carrier, each sorbent layer consisting of at least one sorbent material, offering selective adsorption of CO₂ over other major non condensable gases in air in the presence of moisture or water vapor. The sheet or laminate design is optimized towards maximizing the fraction of active adsorbent (greater than 75% or greater than 60%) in order to reduce the overall volume of the contactor at fixed CO₂ capture capacity.

According to the present disclosure, there is also at least one protective layer comprising a microporous material disposed around the support layer and the sorbent layer, which may control the flow of a suitable desorbing media therethrough. The protective layer in some examples also has a greater hydrophobicity than the sorbent material. Advantageously, the hydrophobic protective layer controls the access of liquid water through the sorbent material, for example, by minimizing and/or preventing the entry of liquid water therein. This is especially beneficial when steam is used as the desorbing media.

In some examples according to the present disclosure, at least one support layer includes a plurality of lumens extending therethrough, and the stream of desorbing media is injected by flow-through through said lumens to start the desorption of CO₂. In some examples, the stream of desorbing media is injected through the lumens in a direction substantially orthogonal or perpendicular to a direction in which the ambient atmospheric air flows through the parallel fluid passages. In some examples, the lumens are interconnected with each other. Advantageously, the lumens allow the stream of desorbing media to flow through the support layer of the sorbent layers in an effort to provide efficient heat transfer to the sorbent while minimizing sorbent contact with liquid water. The lumens increase the proximity of the desorbing media to the adsorber element (e.g., the sorbent materials of the sorbent layers) to facilitate more a proactive adsorption/desorption process.

Additionally and preferably, the adsorber structure of the '747 Climeworks publication contains spacer elements to maintain open parallel passages throughout the structure while minimizing flow resistance through the contactor.

However, even though the goal of optimizing the sheet or laminate design as disclosed in the '747 Climeworks publication is for “maximizing the fraction of active adsorbent (greater than 75% or greater than 60%) in order to reduce the overall volume of the contactor at fixed CO₂ capture capacity” of the sheet or laminate design, the use of inactive material for the spacer elements in the '747 Climeworks publication limits such optimization. In this regard, the present disclosure beneficially facilitates further optimization by using spacer elements that are made at least partially of a sorbent material configured to facilitate adsorption and desorption through the spacer elements. Advantageously, the spacer elements according to the present disclosure would increase a ratio of a sorbent mass of the adsorber element to a total mass of the adsorber element to further maximize the fraction of active adsorbent that is otherwise possible according to the '747 Climeworks publication, in order to reduce the overall volume of the contactor at fixed CO₂ capture capacity. As such, the spacer elements as disclosed herein comprising the sorbent material may provide additional volume or mass of sorbent material, in order to advantageously increase a ratio of a sorbent mass of the adsorber element to a total mass of the adsorber element, which beneficially improves the adsorptive and desorptive property of the device as a whole, as explained above. Furthermore, in some examples, a protective layer comprising a microporous material may be disposed around the spacer elements to provide protection for the spacer elements from the surrounding or external elements.

A method is proposed in the '747 Climeworks publication for separating gaseous carbon dioxide from a gas mixture in the form of ambient atmospheric air, containing said gaseous carbon dioxide as well as further gases different from gaseous carbon dioxide by cyclic adsorption/desorption using a sorbent material adsorbing said gaseous carbon dioxide, using a unit containing an adsorber structure with said sorbent material. The adsorber structure can sustain temperatures of at least 60° C. for the desorption of at least said gaseous carbon dioxide and the unit is openable to flow-through of the gas mixture and for contacting it with the sorbent material for the adsorption step. According to the proposed method, the carbon dioxide capture fraction, defined as the percentage of carbon dioxide captured from the gas mixture in an adsorption step by the sorbent material, is preferably in the range of 10-75%.

The adsorber structure is also designed to sustain large swings in adsorbed water loading both mechanically and chemically during periodic injection of and exposure to a desorbing media such as steam. According to the '747 Climeworks publication, the adsorber structure comprises an array of individual adsorber elements, in the form of sheets or laminates—each adsorber element comprising at least one layer containing a selective porous or permeable solid adsorbent for CO₂ capture, wherein the adsorber elements in the array are arranged essentially parallel to each other and spaced apart essentially evenly from each other forming essentially parallel fluid passages for flow-through of gas mixture and/or steam. The open space between sheets is preferably preserved by the insertion of spacer elements attached to the adsorbent sheets.

According to the present disclosure, the spacer elements comprise a sorbent material configured to facilitate adsorption and desorption through the spacer elements. The spacer elements increase a ratio of a sorbent mass of the adsorber element to a total mass of the adsorber element. Advantageously, the spacer elements as disclosed herein provides additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

According to the '747 Climeworks publication, the adsorber structure comprises an array of individual adsorber elements, each adsorber element comprising at least one, preferably porous, support layer and at least one attached or integrated (surficial) sorbent layer. Said sorbent material preferably offers selective adsorption of CO₂ over other major non-condensable gases in air in the presence of moisture or water vapor.

Typically, in the adsorber structure of the '747 Climeworks publication, individual but essentially identical adsorber elements form a regular aligned stack, the adsorber elements being arranged essentially congruently along the height of the stack, and wherein the distance between neighboring adsorber elements is essentially the same over essentially the whole stack.

The adsorber structure of the '747 Climeworks publication can take the form of a carrier layer, preferably porous carrier layer, and on both sides thereof at least one sorbent layer. The adsorber structure may also be based on a porous carrier layer; a surface layer portion on one or both sides is chemically modified or coated in a way as to provide for the CO₂ adsorption property. Further, the adsorber structure may be formed by a porous carrier layer, which also has the property of acting as the sorbent.

The adsorber elements of the '747 Climeworks publication in the array are arranged essentially parallel to each other and spaced apart from each other forming parallel fluid passage for flow-through of gas mixture and/or steam.

Flow-through of gas mixture in this context is generally to be understood as flowing along the parallel fluid passages and parallel to the sorbent layers to allow for adsorption of the carbon dioxide on said sorbent layers. The flow speed, or through-flow velocity, of the ambient atmospheric air through the adsorber structure as defined here is the airflow speed not at the intake opening of the whole sorbent structure but is the air flow speed in these parallel fluid passages in step (d), and the same applies to the flow speed of the steam through the adsorber structure in step (d). In general, a flow-through includes at least three types of flow as shown in FIG. 4B. The first type (e.g., flow-through 401) is a flow-through that travels parallel to a surface of a structure, such as a sorbent layer or adsorber element 5, and may include a flow running through a space between two structures, such as two sorbent layers (e.g., the fluid passages 7 between the adsorber elements 5) or opposing walls of a channel (e.g., the opposing walls of the lumens 102 shown in FIG. 4A). The second type (e.g., flow-through 402) is a flow-through that travels through into a surface and through the material such as that of a porous sorbent layer that is supported by the surface (e.g., through the adsorber element 5), allowing the air to diffuse out of a surface on the other side of the structure. The first type of flow-through may change into the second type of flow-through after traveling through the material, and vice versa. The third type (e.g., flow-through 403) is a flow-through representing a total movement of a mass of gas mixture which travels through a structure (e.g., the adsorber structure 6) over a given time, which may include one or both of the first and/or second types of flow-through as explained above.

Of course in such an adsorber structure of the '747 Climeworks publication in the form of a stack the outermost adsorber elements may also just have a carrier or porous layer and on the inner side thereof at least one sorbent layer.

The process gas of the '747 Climeworks publication flows primarily in a direction co-planar to the sheet or laminates between an inlet and an outlet for the stack. The solid structure sorbent has typically only two parallel sides opened in order to channel the process gas flow through the structure adsorbent bed and provide means of mechanical assembly into the separation unit. Alternatively, two sets of two parallel sides are open to flow, with one process gas, such as the adsorption gas flow, flowing from one side to the opposing parallel side, and another process gas, such as steam flow, flowing from another third side to the parallel fourth side.

The method according to the '747 Climeworks publication comprises at least the following sequential and in this sequence repeating steps (a)-(e):
(a) contacting said gas mixture in the form of ambient atmospheric air with the sorbent material to allow at least said gaseous carbon dioxide to adsorb on the sorbent material by flow-through through said parallel fluid passages under ambient atmospheric pressure conditions and ambient atmospheric temperature conditions in an adsorption step; thus normally capturing 10% to 75% of CO₂ passing the adsorber structure,
(b) isolating said sorbent with adsorbed carbon dioxide in said unit from said flow-through of ambient atmospheric air while maintaining the temperature in the sorbent;
(c) injecting a stream of saturated or superheated steam by flow-through through said parallel fluid passages (4) and thereby inducing an increase of the temperature of the sorbent to a temperature between 60 and 110° C., optionally also inducing an increase in internal pressure of the reactor unit, and starting the desorption of CO₂;
(d) extracting at least the desorbed gaseous carbon dioxide from the unit and separating gaseous carbon dioxide from steam by condensation in or downstream of the unit, while still contacting the sorbent material with steam by injecting and/or (partially) circulating saturated or superheated steam into said unit, thereby flushing and purging both steam and CO₂ from the unit, normally at a molar ratio of steam to carbon dioxide between 4:1 and 40:1, while regulating the extraction and/or steam supply to essentially maintain the temperature in the sorbent at the end of the preceding step (c) and/or to essentially maintain the pressure in the sorbent at the end of the preceding step (c);
(e) bringing the sorbent material to ambient atmospheric temperature conditions.

The steam downstream of the unit of the '747 Climeworks publication is either condensed or circulated in step d), or only a portion of the steam downstream of the unit is circulated and the remainder is condensed. Control of the molar steam/CO₂ ratio in step (d) can, without particular efforts and based on monitoring of this ratio by corresponding sensors in the unit and/or upstream or downstream of the unit, be adapted by the corresponding inflow and pressure level/temperature level of steam introduced into the unit and the pump and valve operation of the unit. The ratio is also a function of sorbent properties and local steam flow. The given range refers to the conditions at which desorption is considered viable.

The throughflow of gas, explicitly CO₂, is regulated so as to produce a partial pressure of steam to achieve the goal temperature and/or pressure in step (c) according to the '747 Climeworks publication. During step (c) steam can be injected in the form of fresh steam introduced by way of the corresponding inlet, however steam may also be at least partly or fully recirculated from the outlet of steam, if need be, such a recirculation involves reheating of recirculated steam. If such steam recirculation takes place, the recirculated steam at least at the end of the process is not pure steam but carries desorbed carbon dioxide as well. The regulation aims at producing a partial pressure of steam to achieve the goal temperature and/or pressure in step (c) in the variant of the proposed process, where there is at least partial recirculation of steam in step (c), so where a mixture of CO₂ and steam are injected in step (c), thus a certain portion of gases defined by the composition of the inlet gases is preferably continuously extracted. Conversely, in the variant where only fresh steam is supplied, no CO₂ need be preferably extracted within step (c) until the condition for continuing with step (d) is met. So in the above step (c) there is no or no substantial extraction of desorbed gaseous carbon dioxide from the unit, but only injection of said stream of saturated or superheated steam for the situation where only fresh steam is used, while if not only fresh steam but also recirculated steam or only recirculated steam is used in step (c), there can and preferably is at least partial extraction of carbon dioxide during step (c).

The conditions of the process of the '747 Climeworks publication are controlled such that in this step (c) by virtue of the injection of the stream of saturated or superheated steam the internal pressure of the reactor increases. The increase in pressure is for example due to the expansion of the steam in the reactor, and typically the pressure increase is controlled by adapting the valve and pump operation of the unit and/or the pressure and/or temperature level of the stream of saturated or superheated steam injected into the unit as is known to the skilled person. For a typical process the pressure is increasing from a level as given in step (b) to a value in the range of 200 mbar to 1500 mbar in this step (d).

In step (a) according to a first characterization the flow speed of the gas mixture through the adsorber structure is in the range of 2-9 m/s or 2-8 m/s, and at least in step (d) the flow speed of the steam through the adsorber structure is at least 0.2 m/s, preferably in the range of 0.3-1.0 m/s if the flow plane is the same as that of the air during adsorption, or 1-6 m/s if the flow is mostly orthogonal to that of the airflow during adsorption. The flow speed is defined as the mean speed of the corresponding medium in the slots (fluid passages) between the individual absorber elements of the adsorber structure.

In the context of the '747 Climeworks publication, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 bar(abs) and typically ambient atmospheric temperature refers to temperatures in the range of −40 to 60° C., more typically −30 to 45° C. The gas mixture used as input for the process is ambient atmospheric air, i.e. air at ambient atmospheric pressure and at ambient atmospheric temperature, which normally implies a CO₂ concentration in the range of 0.03-0.06% by volume. However, also air with lower or higher CO₂ concentration can be used as input for the process, e.g. with a concentration of 0.1-0.5% by volume, so generally speaking preferably the input CO₂ concentration of the input gas mixture is in the range of 0.01-0.5% by volume.

According to a preferred embodiment of the '747 Climeworks publication, in step (a) the flow speed of the gas mixture through the adsorber structure is in the range of 1-6 m/s.

According to yet another preferred embodiment of the '747 Climeworks publication, at least in step (d) the flow speed of the steam through the adsorber structure is in the range of 0.3-6 m/s.

At least in step (d) the flow speed of the steam through the adsorber structure can be in the range of 0.3-1.0 m/s if the flow of the gas mixture in step (a) and the flow of the steam is step (d) are essentially along the same flow path.

At least in step (d) the flow speed of the steam through the adsorber structure can be in the range of 1-6 m/s if the flow of the gas mixture in step (a) and the flow of the steam is step (d) are along different flow path flows, further preferably if the flow of steam in step (d) is essentially orthogonal to that of the gas mixture in step (a).

An alternative second or additional characterization of the process of the '747 Climeworks publication is not by way of the flow speed of the steam and of the gas mixture, but by way of the specific flow rate of the corresponding flow.

The flow rate conditions based on calculations can be summarized as follows:

| | range flow air [m3/h] | | range flow steam [kg/h] | |
|---|---|---|---|---|
| adsorber | 100000 | 650000 | 6000 | 20000 |
| mass [kg] | specific flow of air [m3/h/kg] | | specific flow of steam [kg/h/kg] | |
| 75 | 1333 | 8667 | 80 | 267 |
| 3000 | 33 | 217 | 2 | 7 |

| | | |
|---|---|---|
| Range: | 33-8667 m3/h/kg | 2-267 kg/h/kg |

| | range flow air [m3/h] | | range flow steam [kg/h] | |
|---|---|---|---|---|
| adsorber | 100000 | 650000 | 6000 | 20000 |
| volume [m3] | specific flow of air [m3/h/m3] | | specific flow of steam [kg/h/m3] | |
| 1.5 | 66667 | 433333 | 4000 | 13333 |
| 20 | 5000 | 32500 | 300 | 1000 |

| | | |
|---|---|---|
| Range: | 5000-433333 m3/h/m3 | 300-13333 kg/h/m3 |

Accordingly, in step (a) the specific flow rate of the gas mixture through the adsorber structure, as a function of the mass of the sorbent, can be adapted to be in the range of 20-10,000 m³/h/kg, preferably in the range of 30-9,000 or 100-7,000 m ³/h/kg. These values are generally to be understood as the average values of the specific flow rate of the gas mixture over the time span of step (a).

In step (a) the specific flow rate of the gas mixture through the adsorber structure, as a function of the volume of the sorbent, can be adapted to be in the range of 4,000-500,000 m³/h/m ³, preferably in the range of 5,000-450,000 or 10,000-300,000 m³/h/m ³.

At least in step (d) the specific flow rate of the steam through the adsorber structure, as a function of the mass of the sorbent, can be adapted to be in the range of 1-500 kg/h/kg, preferably in the range of 2-300 or 50-250 kg/h/kg. Also, these values are generally to be understood as the average values of the specific flow rate of the steam mixture over the time span of the respective step.

At least in step (d) the specific flow rate of the steam through the adsorber structure, as a function of the volume of the sorbent, can be adapted to be in the range of 200-15,000 kg/h/m ³, preferably in the range of 300-14,000 or 500-10,000 kg/h/m ³.

For DAC capture processes of the '747 Climeworks publication in particular, the carbon dioxide capture fraction, defined as the percentage of carbon dioxide captured from the gas mixture in an adsorption step by the sorbent material can be in the range of 10-75%, preferably in the range of 30-60%. Alternatively, or additionally the amount of carbon dioxide captured on the sorbent per gram sorbent can be at least 0.1 or in the range of 0.1-1.8 mmol/g for an adsorption time span of at least 5 or at least 10 minutes. Alternatively characterized the normalized amount of carbon dioxide captured on the sorbent per gram sorbent per hour can be in the range of 0.5-10 mmol/g/h, preferably in the range of 1-6 mmol/g/h.

The carrier layer of the '747 Climeworks publication optionally may include at least one of metal, polymer, carbon, carbon molecular sieve and graphene material. The first sorbent layer may comprise a first sorbent material, and the second sorbent layer may comprise a second sorbent material, where the first and second sorbent material may have a different material or chemical compositions and/or physical characteristics.

In a preferred embodiment of the '747 Climeworks publication, the adsorber structure comprises an array of individual adsorber elements, each element comprising at least one layer containing a selective porous/permeable solid adsorbent for CO₂ capture, wherein the adsorber elements in the array are arranged essentially parallel to each other and spaced apart essentially evenly from each other forming essentially parallel fluid passages for flow-through of gas mixture and/or steam. The open space between sheets can be preserved by the insertion of spacer elements attached to the adsorbent elements.

In the present disclosure, the spacer elements comprise a sorbent material configured to facilitate adsorption and desorption through the spacer elements. The spacer elements increase a ratio of a sorbent mass of the adsorber element to a total mass of the adsorber element. Advantageously, the spacer elements as disclosed herein provides additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

The concept may, in an alternate embodiment of the '747 Climeworks publication, include an adsorber element with a first sorbent layer and a second sorbent layer, where the first sorbent layer and the second sorbent layer are juxtaposed.

In a further preferred embodiment of the '747 Climeworks publication, the above adsorber elements are arranged to a parallel passage contactor, comprising a plurality of adsorber elements as described previously. The plurality of elements forms parallel fluid passages, where each passage is bounded at least in portion by the first sorbent layer of one adsorber element, and at least in portion by the second sorbent layer of the neighboring adsorber element.

Preferably in the '747 Climeworks publication, the spacing between the adsorber elements (height of the fluid passages between the adsorber elements) is in the range of 0.2-5 mm, further preferably in the range of 0.4-3 mm.

In the present disclosure, the spacing between the adsorber elements are maintained using the spacer elements that comprise a sorbent material configured to facilitate adsorption and desorption through the spacer elements. The spacer elements increase a ratio of a sorbent mass of the adsorber element to a total mass of the adsorber element. Advantageously, the spacer elements as disclosed herein provides additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

Further preferably in the '747 Climeworks publication, each adsorber element has the form of a plane with a thickness (perpendicular to the plane) in the range of 0.1-1 mm, preferably in the range of 0.2-0.5 mm.

In the present disclosure, the plane of 0.2-0.5 mm is surrounded by at least one protective layer comprising a hydrophobic microporous material and may include lumens formed through the adsorber element plane such that the lumens are positioned in parallel with the surfaces of the adsorber element plane, for example. Advantageously, the hydrophobic protective layer controls the access of liquid water through the sorbent material of the adsorber element plane, for example, by minimizing and/or preventing the entry of liquid water therein. This is especially beneficial when steam or hot liquid (or any other type of heat-transfer fluid in a liquid form) is used as the desorbing media. In this regard, the lumens increase the proximity of the desorbing media (and heat) to the adsorber element plane to facilitate more a proactive adsorption/desorption process.

The above embodiment of the adsorber structure of the '747 Climeworks publication is embedded in a gas separation process to remove at least one first component from a multi-component gas stream, more specifically, in an adsorption/desorption process for the removal and capture at high purity of CO₂ from ambient air, and likely also a second component, namely gaseous water. The proposed method at least comprises the following sequential and in this sequence repeating steps, occurring with the adsorber structure within a reactor unit:

(a) ADSORPTION: Contacting said multi-component gas mixture with the multitude of sorbent layers at the bounds of the parallel fluid structures formed by the plurality of adsorber elements, by forcing the multi-component fluid from an inlet side of the adsorber structure to an outlet side of the adsorber structure—to allow at least said first component, preferably gaseous carbon dioxide, but potentially also a second component, likely gaseous water, to adsorb on the sorbent material of the sorbent layers bounding the parallel passages under ambient atmospheric pressure conditions and ambient atmospheric temperature conditions in an adsorption step.

This step of the '747 Climeworks publication is the flow-through adsorption step, typically carried out in a unit having two doors at opposite ends of the unit, which for this process step are both open, such that a fan or ventilation device may induce the flow of the multi-component gas stream through the parallel passages, where the pressure drop across the adsorber structure is normally between 200 Pa and 1200 Pa, more preferably between 200 Pa and 750 Pa or 200 Pa and 600 Pa at average fluid velocities within the parallel fluid passages of between 2 m/s and 9 m/s, more preferably between 4 m/s and 6 or 7 m/s, for a duration of 5 min to 40 min, preferably 10 min to 20 min. In the embodiments, this step is termed step (1).

(b) ISOLATION: Isolating said adsorber structure with adsorbed components, preferably carbon dioxide, in said unit from said flow-through while maintaining the temperature in the sorbent and then optionally evacuating said unit to a pressure in the range of 20-200 mbar(abs), or 700-1000 mbar(abs). If carried out in a unit as described in the preceding paragraph, this means that in a first sub-step (in the embodiments termed step (2)) the two doors are first closed and then in a second (optional) sub-step a vacuum is applied (in the embodiments termed step (3)) within this step (b). In the embodiment indicated by FIG. 11, no vacuum was applied—so no evacuation can be applied and the adsorber structure can remain at essentially the ambient atmospheric pressure of step (a) or within ±100 mbar of it.

(c) HEAT: Injecting a stream of saturated or superheated steam and thereby inducing an increase in internal pressure of the reactor unit (only for the case in which before a vacuum was applied in step (b)) and in any case an increase of the temperature of the adsorber structure from normally ambient atmospheric temperature to a temperature between 60 and 110° C., starting the desorption of CO₂. The injected flow of steam should suffice to bring the adsorber structure to the desired temperature within 0.5 min to 15 min, preferably between 0.5 min and 10 min. In the embodiments, this step is termed step (5).

What is important about this step (c) of the '747 Climeworks publication is that the heating of the adsorber structure is taking place exclusively by way of contact with this stream of saturated or superheated steam, there is no additional heat input such as for example by way of internal or external heat exchange elements or the like. The contact of the steam with the adsorber structure therefore at the same time leads to heating as well as starting of the desorption process. During this step (c) steam can be injected in the form of fresh steam introduced by way of the corresponding inlet, however steam may also be recirculated from the outlet of steam, if need be, such a recirculation involving reheating of recirculated steam. If such steam recirculation takes place, the recirculated steam at least at the end of the process is not pure steam but carries desorbed carbon dioxide as well.

(d) EXTRACTION: Extracting at least the desorbed gaseous carbon dioxide from the unit and separating gaseous carbon dioxide from steam by condensation in or downstream of the unit. The injected flow of steam should suffice to extract economically feasible amounts of CO₂ within 0.5 min to 15 min, preferably between 0.5 min and 10 min. In the embodiments, this step is termed step (6).

During this step (d) preferably still saturated or superheated steam is injected into said unit or circulated through the unit as described above, thereby flushing and purging both steam and CO₂ from the unit.

Step (d) normally occurs at a molar ratio of steam to carbon dioxide between 4:1 and 40:1 (preferably calculated as the cumulative value over the full step, so taking the total steam and the total CO₂ during the step), and is controlled so by regulating the extraction and/or steam supply to essentially maintain the temperature in the sorbent at the end of the preceding step (c).

Typically, in this step (d) the temperature in the unit is maintained at a level which is in a window of ±20° C. from the temperature of the sorbent at the end of the preceding step (c), preferably in a window of ±10° C. or ±5° C.

Alternatively or additionally, the process in step (d) can be controlled in that the pressure in the unit at the end of the preceding step (c) is essentially maintained, which means that the pressure in the unit is maintained at a level which is in the window of ±0.2 bar, preferably in a window of ±0.1 bar from the pressure in the unit at the end of the preceding step (c). (e) Bringing the adsorber structure to ambient atmospheric pressure conditions and ambient atmospheric temperature conditions, preferably by opening the doors of the adsorber structure in a first sub-step (in the embodiments termed step (8)) and by flushing with said gas mixture in the form of ambient air in a second sub-step (in the embodiments termed step (9)).

According to a preferred embodiment of the '747 Climeworks publication, after step (d) and before step (e) the following step is carried out:

(d1) ceasing the injection and, if used, circulation of steam, and evacuation of the unit to pressure values between 20-500 mbar(abs), preferably in the range of 50-250 mbar(abs) in the unit, thereby causing evaporation of water from the sorbent and both drying and cooling the sorbent. In the embodiments, this step is termed step (7).

This step (d1) is a preferred step, since it unexpectedly allows combining two effects in one single step: after the steam treatment the sorbent needs to be cooled down to ambient conditions again, but, more importantly, it also needs to be dried. This step allows the combination of these two features in one single processing step, which makes the process quicker and more economical. Drying sufficiently has been shown to be important to the successful operation of such processes relying on fast kinetics resulting from short diffusion lengths.

After step (b) and before step (c) the following step can be carried out: (b1) flushing the unit of non-condensable gases by a stream of non-condensable steam while essentially holding the pressure of step (b), preferably holding the pressure of step (b) in a window of ±50 mbar, preferably in a window of ±20 mbar and/or holding the temperature below 75° C. or 70° C. or below 60° C., preferably below 50° C.

In a further embodiment of the step b1 of the '747 Climeworks publication, the temperature of the adsorber structure rises from the conditions of step (a) to 80-110° C. preferably in the range of 95-105° C.

In the embodiments, this step of the '747 Climeworks publication is termed step (4).

In step (b1) the unit can preferably be flushed with saturated steam or steam overheated by at most 20° C. in a ratio of 0.3-13.3 kg/h per L or 1 kg/h to 10 kg/h of steam per liter volume of the adsorber structure, while remaining at the pressure of step (b1), to purge the reactor of remaining ambient air. The purpose of removing this portion of ambient air is to improve the purity of the captured CO₂.

In step (c), steam can be injected in the form of steam introduced by way of a corresponding inlet of said unit, and steam can be recirculated from an outlet of said unit to said inlet, preferably involving reheating of recirculated steam, or by the reuse of steam from a different reactor.

In step (c) furthermore preferably the sorbent can be heated to a temperature in the range of 80-110° C. or 80-100° C., preferably to a temperature in the range of 85-98° C.

According to yet another preferred embodiment of the '747 Climeworks publication, in step (c) the pressure in the unit is in the range of 700-950 mbar(abs), preferably in the range of 750-900 mbar(abs).

According to yet another preferred embodiment of the '747 Climeworks publication, in step (c) the pressure of the unit varies less than +/100 mbar more preferably less than +/−50 mbar from the pressure of step (b). A particularly efficient release and take out of carbon dioxide is surprisingly possible if the steam is passing the adsorber structure and the sorbent layers contained therein at a particularly elevated speed (typically while keeping the volume flow the same as in conventional processes). This high-speed steam purge can be implemented very efficiently in that the steam in step (c) and/or (d) takes a different path to the flow of air within the parallel passages during adsorption in step (a) in order to increase local steam velocity in the parallel passages of the adsorber structure during desorption. Preferably and very efficiently, the overall flow paths of adsorption during step (a) and during steam injection in step (c) and/or (d) can be chosen to be essentially orthogonal. In line with this, according to another preferred embodiment in step (c) and/or in step (d) the flow velocity of the steam in the adsorber structure is above 0.1 m/s, preferably in the range of 0.3-1 m/s for flow in the adsorption flow direction, and, more preferably in the range of 1-6 m/s in the flow direction orthogonal to the adsorption flow direction.

As pointed out above in the '747 Climeworks publication, flow-through of gas mixture here is generally to be understood as flowing along the parallel fluid passages and parallel to the sorbent layers to allow for adsorption of the carbon dioxide on said sorbent layers. Typically, the sorbent structure provides for a stack of flow-through slots, the boundary surfaces of which are provided by the sorbent material layers. During adsorption in step (a) the ambient airflows through these slots in a first direction. During step (c) and/or (d) the flow direction can be the same as during step (a), but it can preferably be given as a flow in an opposite direction through the flow-through slots, or it can be provided as a flow in a direction at a right angle to the flow through direction during adsorption in step (a). For the situation where in step (a) the flow through slots between the sorbent layers are bordered laterally by side walls, while the intake side and the outlet side of the flow-through slot is open during adsorption in step (a), the latter can be implemented by providing openings at opposite side walls for entry and respective exit of steam while closing the intake side and the outlet side open during adsorption in step (a). So the different path for adsorption and steam injection can be implemented in practice by having a unit with a housing structure which has a short flow through length along a first direction, which is the adsorption flow through direction, and which has a long flow through length along a second, preferably orthogonal direction, which is the desorption flow through direction for the steam. This in particular to make sure that the steam contacts as much as possible of the sorbent while passing through the unit. For this, the unit may have a large opening at two opposing ends of the adsorption flow through direction, which are open during adsorption, and which are closed during desorption, and smaller openings in opposing circumferential side walls of the unit for the desorption, which are closed during adsorption and which are open during desorption for passing the steam through for desorption in a direction orthogonal to the one during adsorption.

As pointed out above in the '747 Climeworks publication, said unit is preferably able to sustain a vacuum pressure of 400 mbar(abs) or less, and step (b) preferably includes isolating said sorbent with adsorbed carbon dioxide in said unit from said flow-through while maintaining the temperature in the sorbent and then evacuating said unit to a pressure in the range of 20-400 mbar(abs), and wherein step (e) includes bringing the sorbent material to ambient atmospheric pressure conditions and ambient atmospheric temperature conditions, and wherein preferably after step (d) and before step (e) the following step is carried out.

According to yet another preferred embodiment of the '747 Climeworks publication, step (d1) involves ceasing the injection and, if used, circulation of steam, and evacuation of the unit to pressure values between 20-500 mbar(abs), preferably in the range of 50-250 mbar(abs) in the unit, thereby causing evaporation of water from the sorbent and both drying and cooling the sorbent.

Step (c) can be carried out exclusively by contacting said gas mixture with the sorbent material under ambient atmospheric pressure conditions and ambient atmospheric temperature conditions to evaporate and carry away water in the unit and to bring the sorbent material to ambient atmospheric temperature conditions.

Preferably in the '747 Climeworks publication, said gas mixture in step (a) flows through said parallel fluid passages essentially along a first direction, and wherein said steam in at least one or both of steps (c) and (d) flows essentially along that same first direction or a direction essentially opposite to said first direction.

Alternatively in the '747 Climeworks publication, said gas mixture in step (a) flows through said parallel fluid passages essentially along a first direction, and wherein said steam at least one or both of steps (c) and (d) flows essentially along a direction orthogonal to said first direction through said parallel fluid passages.

Furthermore, the '747 Climeworks publication relates to a device for carrying out a method for separating gaseous carbon dioxide from a gas mixture in the form of ambient air, containing said gaseous carbon dioxide as well as further gases different from gaseous carbon dioxide by cyclic adsorption/desorption using a sorbent material adsorbing said gaseous carbon dioxide as detailed above.

Said device of the '747 Climeworks publication comprises: a steam source; at least one unit containing an adsorber structure with said sorbent material, the adsorber structure being heatable to a temperature of at least 60° C. for the desorption of at least said gaseous carbon dioxide and the unit being openable to flow-through of the gas mixture and for contacting it with the sorbent material for an adsorption step, wherein the adsorber structure is given as described above, i.e. comprises preferably an array of individual adsorber elements, each adsorber element comprising a porous support layer and attached or integrated at least one sorbent layer comprising or consisting of at least on sorbent material, or a central carrier layer and on both sides thereof at least one sorbent layer comprising or consisting of at least one sorbent material, wherein the adsorber elements in the array are arranged essentially parallel to each other and spaced apart from each other forming parallel fluid passages for flow-through of gas mixture and/or steam; at least one device, preferably a condenser, for separating carbon dioxide from water.

In the present disclosure, in addition to the at least one sorbent layer comprising at least one sorbent material, at least one protective layer is also provided, comprising a microporous material disposed around the porous support layer and the sorbent layer. The protective layer may have a greater hydrophobicity than the sorbent material. Advantageously, the hydrophobic protective layer controls the access of liquid water through the sorbent material, for example, by minimizing and/or preventing the entry of liquid water therein. This is especially beneficial when steam is used as the desorbing media.

More specifically the '747 Climeworks publication also and also independently of the above method relates to a device for the adsorption and desorption of the sorbent used in cyclically adsorption-desorption for the capture of carbon dioxide, CO₂, directly from ambient atmospheric air, as well as to uses of such a method and devices for such a method.

While much of the experience in DAC processes stems from flue gas capture, the underlying difference is the source of CO₂, which essentially determines the considerable divergence of solutions for both tasks. The lower concentration of CO₂ in ambient atmospheric air compared to flue gas means a large volume of air has to be moved to capture significant amounts of CO₂. Therefore, a low-pressure drop adsorber structure is required if the energy requirements for the movement of said air is to not be prohibitively high. At the same time, there is no requirement as in flue gas capture to assure almost complete capture of CO₂ by the system at capture fractions of 80% or higher. Capture fractions well below 70% are feasible for air capture, providing another incentive to favor structures with low pressure-drop and quick loading.

The pressure drop across such an adsorber structure can be estimated by the following equation:

$$\frac{Δ P}{L} = {K}_{surface} \cdot ( {U}_{i n l e t} ) \cdot {( {b}_{spacer} )}^{- 2} \qquad ( Equation 1 )$$

wherein:
ΔP is the pressure drop across the structure in Pascal [Pa]
L is the length of the parallel passage the gas flows across in adsorption (element length) in centimeters [cm]
K_{surface} is a roughness factor to be determined experimentally, typically in the range of 1 to 10
Uᵢₙₗₑₜ is the velocity on the inlet plane of the adsorber structure (not yet the velocity in the parallel passage) in meters per second [m/s]
b_{spacer} is the height of the spacers determining the width of the parallel fluid passages (spacing width) in millimeters [mm].

Based on calculations further detailed below, a functional relationship can be established, allowing the dimensioning of adsorber structures comprising an array of individual adsorber elements, in the form of sheets or laminates—each adsorber element comprising at least one layer containing a selective porous or permeable solid adsorbent for CO₂ capture, wherein the adsorber elements in the array are arranged essentially parallel to each other and are spaced apart essentially evenly from each other forming essentially parallel fluid passages for flow-through of gas mixture and/or steam.

Correspondingly, the '747 Climeworks publication proposes a device for separating gaseous carbon dioxide from a gas mixture in the form of ambient atmospheric air, containing said gaseous carbon dioxide as well as further gases different from gaseous carbon dioxide by cyclic adsorption/desorption using a sorbent material adsorbing said gaseous carbon dioxide. Preferably this device can be used in a process as described above.

The device comprises: a steam source; at least one unit containing an adsorber structure with said sorbent material, the adsorber structure being suitable and adapted to sustain a temperature of at least 60° C. for the desorption of at least said gaseous carbon dioxide and the unit being openable to flow-through of the gas mixture and for contacting it with the sorbent material for an adsorption step.

The adsorber structure comprises an array of individual adsorber elements in the form of layers, each adsorber element comprising at least one sorbent layer, wherein the adsorber elements in the array are arranged essentially parallel to each other and essentially equally spaced apart from each other forming parallel fluid passages for flow-through of ambient atmospheric air and/or steam, and wherein the individual adsorber elements have an element length L along the flow-through direction of the ambient atmospheric air in an adsorption step (a), wherein the individual adsorber elements have an element thickness bₑₗₑₘₑₙₜ along a direction orthogonal to said flow-through direction, and wherein the spacing between the adsorber elements has a spacing width b_{spacer}; at least one device for separating carbon dioxide from water.

According to a first characterizing aspect of the '747 Climeworks publication, the spacing width b_{spacer} (height of the fluid passages between the adsorber elements) is in the range of 0.4-5 mm, and wherein the element length L is in the range of 100-3000 mm.

According to the '747 Climeworks publication, the open space between sheets is preferably preserved by the insertion of spacer elements attached to the adsorbent sheets.

In the present disclosure, the spacer elements comprise a sorbent material configured to facilitate adsorption and desorption through the spacer elements. The spacer elements increase a ratio of a sorbent mass of the adsorber element to a total mass of the adsorber element. Advantageously, in addition to maintaining the open space between the sheets, the spacer elements as disclosed herein provide additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

Typically, in the adsorber structure individual but essentially identical adsorber elements form a regular aligned stack, the adsorber elements being arranged essentially congruently along the height of the stack, and wherein the distance between neighboring adsorber elements is essentially the same over essentially the whole stack.

According to the '747 Climeworks publication, the adsorber structure comprises an array of individual adsorber elements. Each adsorber element is a composite of a porous support layer or sheet and at least one sorbent layer attached to said porous support such that it is accessible from both sides of the adsorber element. The sorbent layer comprises or consists of at least one sorbent material, offering selective adsorption of CO₂ over other major non-condensable gases in air in the presence of moisture. In an alternate embodiment of the '747 Climeworks publication, the adsorber element comprises a carrier or support layer, with a first and second sorbent layer attached on either side of said carrier, each sorbent layer consisting of at least one sorbent material, offering selective adsorption of CO₂ over other major non-condensable gases in air in the presence of moisture or water vapor. The sheet or laminate design is optimized towards maximizing the fraction of active adsorbent (greater than 60%) in order to reduce the overall volume of the contactor at fixed CO₂ capture capacity.

In the present disclosure, at least one protective layer comprising a microporous material is disposed around the support layer and the sorbent layer, and the protective layer has greater hydrophobicity than the sorbent material. In some examples, each of the porous support layers and the sorbent layers may be individually covered or surrounded by a protective layer. In some examples of the present disclosure, the protective layer may be disposed around the carrier or support layer and the first and second sorbent layers. Advantageously, the hydrophobic protective layer controls the access of liquid water through the sorbent material of the sorbent layer(s), for example, by minimizing and/or preventing the entry of liquid water therein. This is especially beneficial when steam is used as the desorbing media.

In the '747 Climeworks publication, the individual adsorber elements take the form of sheets or laminates—each adsorber element comprising at least one layer containing a selective porous or permeable solid adsorbent for CO₂ capture, wherein the adsorber elements in the array are arranged essentially parallel to each other and spaced apart essentially evenly from each other forming essentially parallel fluid passages for flow-through of gas mixture and/or steam. The open space between sheets is preferably preserved by the insertion of spacer elements attached to the adsorbent sheets.

In the present disclosure, the spacer elements comprise a sorbent material configured to facilitate adsorption and desorption through the spacer elements. The spacer elements increase a ratio of a sorbent mass of the adsorber element to a total mass of the adsorber element. Advantageously, in addition to preserving the open space between the sheets, the spacer elements as disclosed herein provide additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

According to the '747 Climeworks publication, preferably the adsorber structure comprises an array of individual adsorber elements, each adsorber element comprising at least one preferably porous support layer and at least one attached or integrated (surficial) sorbent layer. Said sorbent material preferably offers selective adsorption of CO₂ over other major non-condensable gases in air in the presence of moisture or water vapor,

The adsorber structure can take the form of a carrier layer, preferably a porous carrier layer, and on both sides thereof at least one sorbent layer. The adsorber structure may also be based on a porous carrier layer, a surface layer portion on one or both sides is chemically modified or coated in a way as to provide for the CO₂ adsorption property. Further the adsorber structure may be formed by a porous carrier layer, which also has the property of acting as the sorbent.

The adsorber elements in the array are arranged essentially parallel to each other and spaced apart from each other forming parallel fluid passage for flow-through of gas mixture and/or steam. Of course, in such an adsorber structure in the form of a stack, the outermost adsorber elements may also just have a carrier layer and on the inner side at least one sorbent layer.

The spacing width is preferably in the range of 0.4-5 mm, preferably in the range of 0.4-3 mm or 0.5-3 mm.

The element length (L) is preferably in the range of 100-3000 mm, further preferably in the range of 200-2000 mm.

In a simplified representation, the above equation can be reformulated to express the length L as a function of the other parameters, namely as follows:

$$L = \frac{Δ P \cdot {b}_{s p a c e r}^{2}}{{K}_{linear} \cdot {U}_{i n l e t} \cdot ( 1 + \frac{{b}_{e l e m e n t}}{{b}_{spacer}} )} \qquad ( Equation 2 )$$

wherein the values are typically given in the following ranges (values to be inserted into the above formula using the units given in the examples below):
ΔP: 150-350 Pa (typically for axial fans), 500-700 Pa or 500-750 Pa (typically for radial fans), 1000-1200 Pa (typically for higher power radial fans);
Uᵢₙₗₑₜ is typically in the range of 2-6 m/s;
bₑₗₑₘₑₙₜ, element thickness of the adsorber element: 0.1-0.5 mm;
b_{spacer}: 0.4-5 mm, preferably 0.4-3 mm;
Kₗᵢₙₑₐᵣ: linear roughness factor, typically in the range of 1.0-10.

$${U}_{inlet} \cdot ( 1 + \frac{{b}_{element}}{{b}_{spacer}} )$$

is essentially the velocity within the parallel passages.

This can further be simplified using a global parameter K_{global}.

So the element length (L in [mm]) is preferably given as a function of the spacing width (b_{spacer} in [mm]), and of the element thickness (bₑₗₑₘₑₙₜ in [mm], being defined as the thickness of the adsorber elements measured in a direction perpendicular to the plane of the parallel fluid passages), by the equation:

$$L = \frac{{K}_{global} \cdot {b}_{spacer}^{2}}{( 1 + \frac{{b}_{e l e m e n t}}{{b}_{spacer}} )} \qquad ( Equation 3 )$$

wherein K_{global} is in the range of 70-2500 mm⁻¹, preferably in the range of 200-1000 mm⁻¹. This applies to the boundaries for L and bₑₗₑₘₑₙₜ as given above and as detailed in claim 1, i.e. the values for L calculated according to this formula have to be in the range of 100-3000 mm, or in one of the above-mentioned preferred ranges, but can also, according to a second independent characterization of the '747 Climeworks publication, independently of these boundaries be used for characterizing the dimensioning of the adsorber structure.

The above formula allows specification of a range in length according to technically feasible operating conditions with a pressure drop that can technically be achieved by a fan or ventilator. This range in length is then technically viable for CO₂ capture from ambient air. Preferably, in particular in a device with axial fans for propelling the airflow through the adsorber structure, K_{global} is in the range of 70-1000 mm, preferably in the range of 400-800 mm⁻¹.

In a device with radial fans for propelling the airflow through the adsorber structure, K_{global} is preferably in the range of 200-2000 mm⁻¹, preferably in the range of 800-1500 mm⁻¹. In a device with higher power fans (such as multistage axial or radial fans) for propelling the airflow through the adsorber structure, K_{global} is typically in the range of 500-2500 mm⁻¹, preferably in the range of 1000-2000 mm⁻¹.

In the above equation, preferably bₑₗₑₘₑₙₜ is in the range of 0.1-1 mm, preferably in the range of 0.1-0.5 mm and/or b_{spacer} is in the range of 0.4-5 mm, preferably 0.5-3 mm.

Typically, the adsorber elements of the '747 Climeworks publication comprise a central and preferably porous support layer and composited on both sides thereof at least one sorbent layer.

In the present disclosure, at least one protective layer comprising a microporous material is disposed around the support layer and the sorbent layer, and the protective layer has greater hydrophobicity than the sorbent layer. Advantageously, the hydrophobic protective layer controls the access of liquid water through the sorbent material on both sides of the support layer and the sorbent layer, for example, by minimizing and/or preventing the entry of liquid water therein. This is especially beneficial when steam is used as the desorbing media.

The adsorber structure of the '747 Climeworks publication preferably comprises an array of individual adsorber elements, each adsorber element a composite of a preferably porous support layer and at least one porous and/or permeable sorbent layer with chemically attached carbon dioxide capture moieties, preferably in the form of amine groups, wherein the porous sorbent layer is preferably in the form of a woven or non-woven, fiber-based structure.

Preferably said carrier support layer of the '747 Climeworks publication is based on at least one of metal, polymer, carbon, carbon molecular sieve and graphene material.

The adsorber elements in the array of the '747 Climeworks publication can be arranged essentially parallel to each other and spaced apart by spacer elements from each other forming parallel fluid passages for flow through of ambient atmospheric air and/or steam.

In the present disclosure, the spacer elements comprise a sorbent material configured to facilitate adsorption and desorption through the spacer elements. The spacer elements increase a ratio of a sorbent mass of the adsorber element to a total mass of the adsorber element. Advantageously, in addition to maintaining the parallel arrangement of the adsorber elements in the array, the spacer elements as disclosed herein provide additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

Preferably in the '747 Climeworks publication, the spacing between the layers is in the range of 0.2-5 mm, further preferably in the range of 0.4-3 mm, and wherein further preferably each adsorber element has the form of a plane with a thickness in the range of 0.1-1 mm, preferably in the range of 0.2-0.5 mm,

The device for separating carbon dioxide from water can be a condenser.

At the gas outlet side of said device for separating carbon dioxide from water, preferably said condenser, there can be at least one of, preferably both of a carbon dioxide concentration sensor and a gas flow sensor for controlling the desorption process. Preferably, the device is suitable and adapted such that in the adsorption step (a) the flow speed of the ambient atmospheric air through the adsorber structure is in the range of 2-9 m/s as described further above. In terms of constructional features this is achieved in that the spacing width (height of the fluid passages between the adsorber elements) and the element length are in the range as specified further above and in that propelling means for the ambient atmospheric air are provided allowing for that flow speed in the adsorber structure.

The flow speed is defined as the mean speed of the corresponding medium in the slots (fluid passages) between the individual absorber elements of the adsorber structure. Alternatively or additionally, it is suitable and adapted such that in a steam flow through step (d) the flow speed of the steam through the adsorber structure is in the range of at least 0.2 m/s. Again, in terms of constructional features this is achieved in that the spacing width (height of the fluid passages between the adsorber elements) and the element length are in the range as specified further above and in that propelling means for the same are provided allowing for that flow speed in the adsorber structure.

Further preferably, the device is suitable and adapted such that in the adsorption step (a) the flow speed of the ambient atmospheric air through the adsorber structure is in the range of 4-6 m/s, or it is suitable and adapted such that in a steam flow through step (d) the flow speed of the steam through the adsorber structure is in the range of 0.3-6 m/s.

According to yet another preferred embodiment of the '747 Climeworks publication, the device comprises means for directing the steam in a steam flow through step (d) along a different flow direction than the flow direction of the flow-through direction of the ambient atmospheric air in the adsorption step (a), preferably along a flow direction orthogonal to the flow-through direction of the ambient atmospheric air in the adsorption step (a).

Preferably at least in a steam flow through step (d) the flow speed of the steam through the adsorber structure is in the range of 1-6 m/s if the flow of the ambient atmospheric air in step (a) and the flow of the steam in step (d) are along different flow path flows, further preferably if the flow of steam in step (d) is essentially orthogonal to that of the ambient atmospheric air in step (a).

Furthermore, the '747 Climeworks publication relates to the use of a device as described above for direct air capture.

The adsorber structure as used in this method comprises a multitude of adsorber elements arranged in an array, each of them comprising of at least one sorbent layer, offering selective adsorption of CO₂ over other major non-condensable gases in air in the presence of moisture or water vapor. The sheet or laminate design is optimized towards maximizing the fraction of active adsorbent (greater than 60% or than 75%) in order to reduce the overall volume of the contactor at fixed CO₂ capture capacity.

Additionally and preferably in the '747 Climeworks publication, the structure adsorbent contains spacer elements to maintain open parallel passages throughout the structure while minimizing flow resistance through the contactor.

In the present disclosure, the spacer elements comprise a sorbent material configured to facilitate adsorption and desorption through the spacer elements. The spacer elements increase a ratio of a sorbent mass of the adsorber element to a total mass of the adsorber element. Advantageously, in addition to maintaining the open parallel passages throughout the structure while minimizing flow resistance through the contactor, the spacer elements as disclosed herein provide additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

The adsorber structure is also designed to sustain large swings in adsorbed water loading both mechanically and chemically during periodic injection of and exposure to steam. According to the '747 Climeworks publication, the adsorber structure comprises an array of individual adsorber elements, in the form of sheets or laminates—each adsorber element comprising at least one layer containing a selective porous or permeable solid adsorbent for CO₂ capture, wherein the adsorber elements in the array are arranged essentially parallel to each other and spaced apart essentially evenly from each other forming essentially parallel fluid passages for flow-through of gas mixture and/or steam. The open space between sheets is preferably preserved by the insertion of spacer elements attached to the adsorbent sheets.

In the present disclosure, the spacer elements comprise a sorbent material configured to facilitate adsorption and desorption through the spacer elements. The spacer elements increase a ratio of a sorbent mass of the adsorber element to a total mass of the adsorber element. Advantageously, in addition to preserving the open spaces between sheets, the spacer elements as disclosed herein provide additional volume or mass of sorbent material, in order to increase a ratio of a sorbent mass of the adsorber element to a total mass of the adsorber element, thereby improving the adsorptive and desorptive property of the device as a whole. Furthermore, in some examples, a protective layer comprising a microporous material may be disposed around the spacer elements to provide protection for the spacer elements from the surrounding or external elements.

According to the '747 Climeworks publication, the adsorber structure comprises an array of individual adsorber elements, each adsorber element comprising or is a composite of a preferably porous support layer and on one or both sides thereof at least one sorbent layer, wherein the adsorber elements in the array are arranged essentially parallel to each other and spaced apart from each other forming parallel fluid passage for flow-through of gas mixture and/or steam. Of course in such an adsorber structure in the form of a stack the outermost adsorber elements may also just have a carrier layer and on the inner side at least one sorbent layer. The process gas flows primarily in a direction co-planar to the sheet or laminates between an inlet and an outlet for the stack. The solid structure sorbent has typically only two parallel sides opened in order to channel the process gas flow through the structure adsorbent bed and provide means of mechanical assembly into the separation unit. Alternatively, two sets of two parallel sides are open to flow, with one process gas, such as the adsorption gas flow, flowing from one side to the opposing parallel side, and another process gas, such as the steam flow, flowing from another third side to the parallel fourth side.

As pointed out above, said unit is preferably able to sustain a vacuum pressure of 400 mbar(abs) or less, and step (b) preferably includes isolating said sorbent with adsorbed carbon dioxide in said unit from said flow-through while maintaining the temperature in the sorbent and then evacuating said unit to a pressure in the range of 20-400 mbar(abs), and wherein step (e) includes bringing the sorbent material to ambient atmospheric pressure conditions and ambient atmospheric temperature conditions.

Preferably, the above-mentioned method or device is used for direct air capture or for recovery of carbon dioxide from ambient atmospheric air.

Further embodiments of the '747 Climeworks publication are laid down in the dependent claims.

### BRIEF DESCRIPTION OF THE DRAWINGS

Preferred embodiments of the disclosure are described in the following with reference to the drawings, which are for the purpose of illustrating the present preferred embodiments of the disclosure and not for the purpose of limiting the same. In the drawings,

FIG. 1 (prior art) shows a schematic representation of required and optional steps for the method presented to attain CO₂ in an economically feasible cyclic adsorption and desorption process as found in '747 Climeworks publication;

FIG. 2 (prior art) shows a schematic of a single adsorber (sorbent) element, as comprising a porous support and at least one sorbent layer as found in the '747 Climeworks publication;

FIG. 2A shows a cross-sectional view of a sorbent element when cut along the line A-A in FIG. 2 according to some embodiments of the present disclosure;

FIGS. 2B and 2C show cross-sectional views of a sorbent element with lumens extending therethrough, in both uncompressed and compressed configurations, according to some embodiments of the present disclosure;

FIGS. 2D and 2E show cross-sectional views of a sorbent element with lumens extending therethrough, in both uncompressed and compressed configurations, according to some embodiments of the present disclosure;

FIG. 2F is an image of interconnected lumens which can be implemented in the sorbent element according to some embodiments of the present disclosure;

FIG. 3 (prior art) shows a schematic of a single adsorber (sorbent) element, as comprising a carrier layer and at least one sorbent layer on either side as found in the '747 Climeworks publication;

FIG. 3A shows a cross-sectional view of a sorbent element when cut along the line A-A in FIG. 3 according to some embodiments of the present disclosure;

FIGS. 3B and 3C show cross-sectional views of a sorbent element with lumens extending therethrough, in both uncompressed and compressed configurations, according to some embodiments of the present disclosure;

FIGS. 3D and 3E show cross-sectional views of a sorbent element with a protective layer, according to some embodiments of the present disclosure;

FIG. 4 (prior art) shows an exemplary schematic of an adsorber structure comprising a plurality of parallel adsorber elements thus forming a plurality of parallel fluid passages as found in the '747 Climeworks publication;

FIG. 4A shows a schematic view of an adsorber structure indicating a first direction for airflow and a second direction for desorbing media, according to some embodiments of the present disclosure;

FIG. 4B shows a schematic view of an adsorber structure showing different types of flow-through of gas mixture traveling within and/or through the structure as disclosed herein;

FIG. 5 (prior art) shows a schematic realization of a reactor unit with the required inlets and outlets for the method presented as found in the '747 Climeworks publication;

FIG. 6 (prior art) shows a schematic of the adsorber structure with the adsorber elements and subsequent parallel fluid passages in vertical orientation, with an indication of the axial, mostly horizontal flow direction of the multi-component flow during adsorption, and a horizontal counter-flow arrangement for the steam during purge as found in the '747 Climeworks publication;

FIG. 7 (prior art) shows a schematic of the adsorber structure with the adsorber elements and subsequent parallel fluid passages in vertical orientation, with an indication of the axial, mostly horizontal flow direction of the multi-component flow during adsorption, and a vertical orthogonal-flow arrangement for the steam during purge as found in the '747 Climeworks publication;

FIG. 8 (prior art) shows a schematic of the adsorber structure with the adsorber elements and subsequent parallel fluid passages in horizontal orientation, with an indication of the axial, mostly horizontal flow direction of the multi-component flow during adsorption, and a horizontal counter-flow arrangement for the steam during purge as found in the '747 Climeworks publication;

FIG. 9 (prior art) shows a schematic of the adsorber structure with the adsorber elements and subsequent parallel fluid passages in horizontal orientation, with an indication of the axial, mostly horizontal flow direction (a) of the multi-component flow during adsorption, and a horizontal orthogonal-flow arrangement (d) for the steam during purge as found in the '747 Climeworks publication;

FIG. 10 (prior art) shows laboratory testing results of an adsorber structure (1″×½″ by 40 mm) for different adsorption conditions, delivering 1.2-1.6 mmol/g as found in the '747 Climeworks publication;

FIG. 11 (prior art) shows average breakthrough curves (top curves) and average CO₂-loading (bottom curves) for experimental operation of embodiment 1, with an adsorber structure (360 mm×360 mm by 100 mm) with parallel passages in vertical orientation and a process including evacuation steps to below 200 mbar(abs) as found in the '747 Climeworks publication;

FIG. 12 (prior art) shows relative breakthrough curves (top curves) and CO₂-loading (bottom curves) for experimental operation of embodiment 2, with an adsorber structure (360 mm×360 mm by 100 mm) with parallel passages in vertical orientation and a process without any evacuation steps as found in the '747 Climeworks publication;

FIG. 13 (prior art) shows a summary of experimental results with an insufficiently long adsorber structure according to embodiment 1 as found in the '747 Climeworks publication;

FIG. 14 (prior art) shows a schematic plant layout as can be used for carrying out the proposed method as found in the '747 Climeworks publication;

FIG. 15 (prior art) shows the pressure drop measured and calculated for various spacer heights and superficial velocities as found in the '747 Climeworks publication;

FIG. 16 (prior art) shows, for different spacer heights in mm, the maximum length of the laminate as a function of the speed in the free air for a pressure drop of 300 Pa as found in the '747 Climeworks publication;

FIG. 17 (prior art) shows, for different spacer heights in mm, the mass of laminate sheets per square meter inlet area as a function of the speed in the free air (inlet velocity prior to parallel passages) for a pressure drop of 300 Pa as found in the '747 Climeworks publication;

FIG. 18 (prior art) shows, for different spacer heights in mm, the time until uptake of 1 mmol/g as a function of speed in the free air for a pressure drop of 300 Pa and capture fraction of 60% as found in the '747 Climeworks publication;

FIG. 19 (prior art) shows a comparative production rate as a function of the speed in free air for different spacer heights in mm for a pressure drop of 300 Pa as found in the '747 Climeworks publication;

FIG. 20 (prior art) shows the ratio of characteristic time of advection and diffusion as a function of the speed in the free air for different spacer heights for a pressure drop of 300 Pa as found in the '747 Climeworks publication;

FIG. 21 (prior art) shows the maximum length of laminate as a function of the speed in the free air for different spacer heights and the DAC window for a pressure drop of 300 Pa as found in the '747 Climeworks publication; and

FIG. 22 (prior art) shows the capture rate and the capture capacity as a function of the adsorption time for a given set of parameters as found in the '747 Climeworks publication.

### DETAILED DESCRIPTION

The embodiments of the present disclosure presented below describe the proposed method in terms of a variable set of process steps, which an adsorber structure is exposed to in a dedicated reaction unit and can be run through in various sequences. The process steps of the method for the preferred embodiments in the '747 Climeworks publication include:
1. CO₂ capture by adsorption of CO₂ onto the adsorber structure by contacting the sorbent layers with sufficient amounts of ambient atmospheric air, with a capture fraction between 10% and 75% (adsorption step (a), mandatory).
2. Isolating the adsorber structure in the reactor from external ambient atmospheric air (isolation step (b), mandatory).
3. Establishing a pressure typically between 50-400 mbar(abs) in the reactor unit by means of evacuation (evacuation step within (b), optional).
4. Flushing the reactor unit of non-condensable gases by an initial flow of non-condensable steam while holding the pressure of step 3 or not allowing the adsorber structure temperature to exceed 75° C. (flushing with steam step (b1), optional).
5. Injecting a stream of saturated or superheated steam at a temperature of typically at least 45° C. and, if evacuation in step 3 took place, inducing an increase in internal pressure of the reactor unit, and an increase of the temperature of the adsorber structure to a temperature between 60 and 110° C., preferably according to the saturation temperature for the current reactor pressure, facilitating the desorption and release of CO₂ (heat up with steam step (c), mandatory).
6. Opening of the reactor unit outlet while still injecting steam, thus flushing and purging both steam and CO₂ from the adsorber structure and reactor unit, typically at a molar ratio of steam to CO₂ between 4:1 and 40:1, while preferably regulating the outflow in such a way to maintain to a degree the pressure achieved at the end of the previous step (purge step with steam (d), mandatory).
7. After ceasing the injection of steam, reduction of unit pressure to values between 50-250 mbar(abs) in the reactor unit by means of evacuation, which causes evaporation of water from the adsorber structure subsequently both drying and cooling the sorbent material (vacuum cool/dry step (d1), optional).
8. Breaking the isolation of the reactor to the ambient atmospheric air and re pressurizing the reactor unit if required (step of breaking isolation and re-pressurization (e), mandatory).
9. Drying of the adsorber structure with warm air between 40° C. and 100° C. (step of air drying (el), optional).

Continue cyclic operation with step 1.

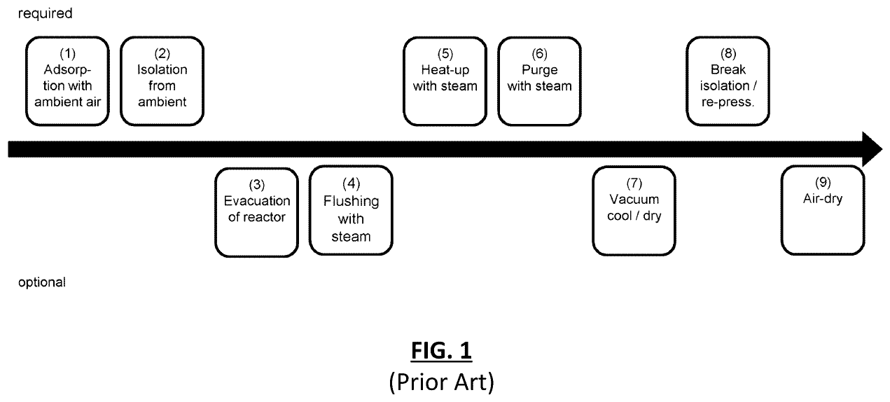

A schematic illustration of this sequence of steps is given in FIG. 1 of the '747 Climeworks publication.

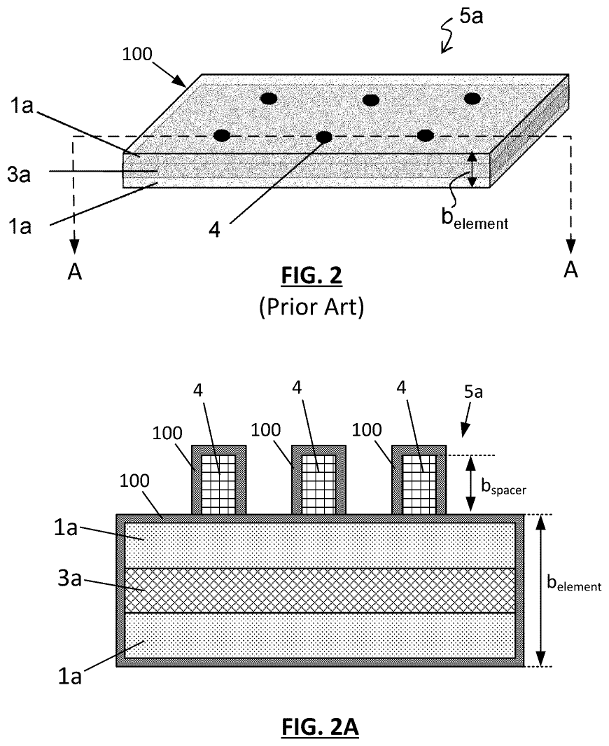

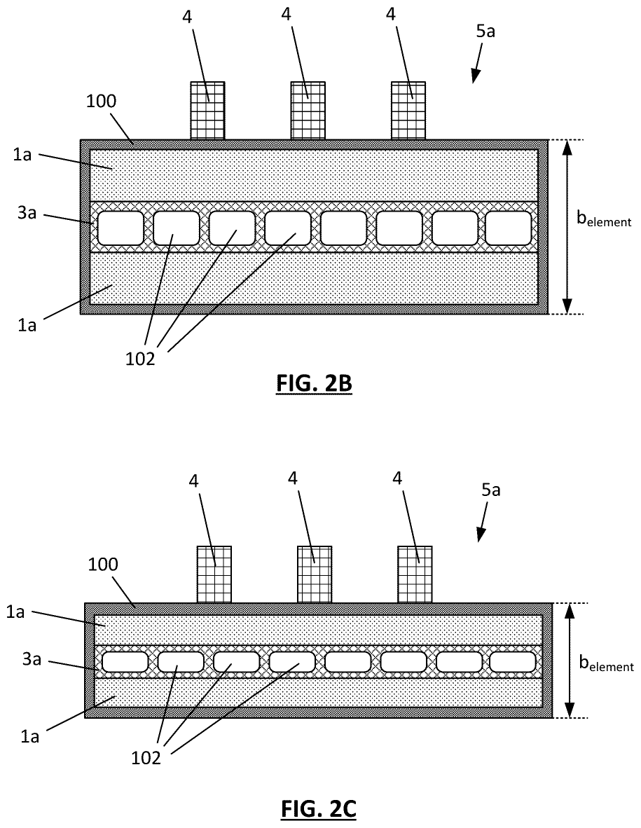

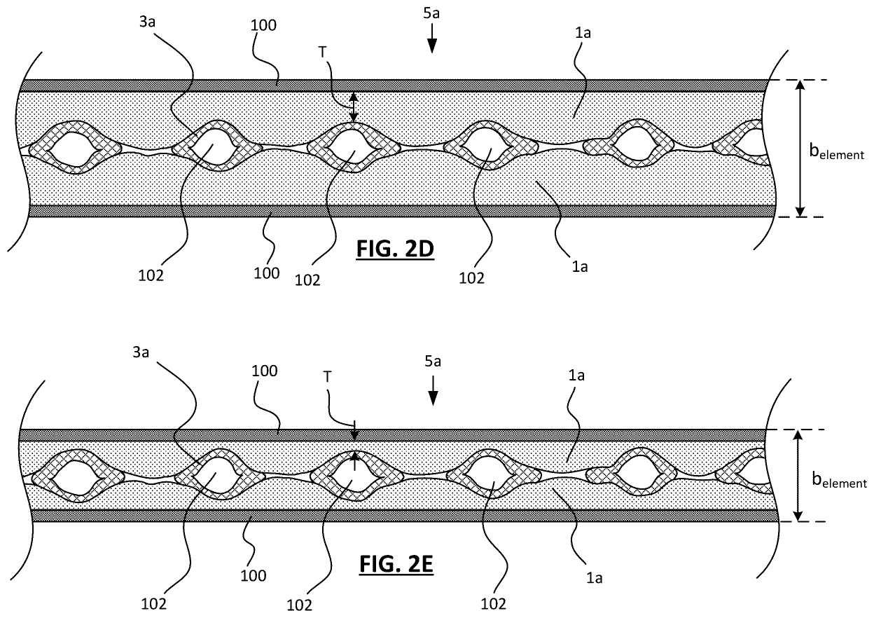

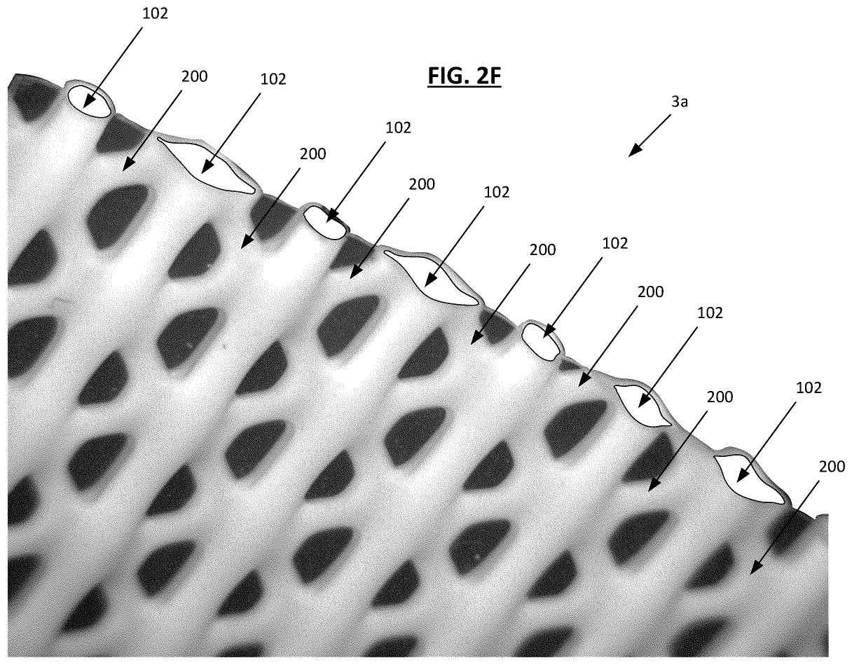

One embodiment of the composition of the individual adsorber elements is shown in FIG. 2 of the '747 Climeworks publication. FIG. 2A as disclosed herein is a cross-sectional view of FIG. 2 as cut along the line A-A. The individual adsorber element 5a comprises at least one sorbent layer 1a on a porous support layer 3a, where said sorbent layer comprises at least one sorbent material containing a selective porous solid adsorbent for CO₂ capture, thus forming a sheet or laminate. The spacing and arrangement of multiple elements is achieved by the insertion of spacer elements 4 on one or both planar sides of the element.

In FIG. 2A of the present disclosure, the adsorber element 5a further includes a protective layer 100 which surrounds the sorbent layer(s) la and the support layer 3a. The protective layer 100 is made of any suitable microporous material including, but not limited to, expanded polyethylene (ePE) or expanded polytetrafluoroethylene (ePTFE), for example. The spacer elements 4 may be disposed on a surface of the protective layer 100 and is also made of any suitable microporous material including but not limited to polyethylene (PE) and polytetrafluoroethylene (PTFE), for example. The protective layer 100 is configured to surround the edges of the sorbent layer(s) la and the support layer 3a of the adsorber element 5a. Furthermore, the example in FIG. 2A shows the protective layer 100 being also disposed around the spacer elements 4 to provide protection for the spacer elements 4 from the surrounding or external elements (e.g., protection from water entering the spacer elements 4).

In FIGS. 2B and 2C, the support layer 3a defines a plurality of lumens 102 extending through the support layer 3a in a direction substantially parallel to the sorbent layer(s) la disposed on one or both sides of the support layer 3a. In some examples, as shown in FIG. 2C, the support layer 3a is made of a pliable material which is capable of partially compressing when a force is applied, in which case the lumens 102 may compress in height, as shown, thereby decreasing the element thickness bₑₗₑₘₑₙₜ as compared to that in FIG. 2B. In some examples, the spacer elements 4 maybe made of a nonpliable or rigid material in order to maintain the height b_{spacer} thereof. In some examples, the spacer element 4 may be made of a partially pliable material which may be compressed partially but still retaining at least a portion of the height b_{spacer} in the uncompressed state. The portion may be at least 50%, at least 60%, at least 70%, at least 80%, at least 90%, or any other suitable value or range therebetween. The lumens 102 facilitate passage of desorbing media, which may be steam, through the adsorber element 5a.

The spacer elements 4 may incorporate a sorbent material such as a CO₂-adsorbing material, which may include, but is not limited to, an ion exchange resin (e.g., a strongly basic anion exchange resin such as Dowex™ Marathon™, a resin available from Dow Chemical Company), zeolite, activated carbon, alumina, metal-organic frameworks, polyethyleneimine (PEI), or another suitable CO₂-adsorbing material, such as desiccant, carbon molecular sieve, carbon adsorbent, graphite, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, chemisorbent, amine, organo-metallic reactant, hydrotalcite, silicalite, zeolitic imadazolate framework and metal organic framework (MOF) adsorbent compounds, and combinations thereof.

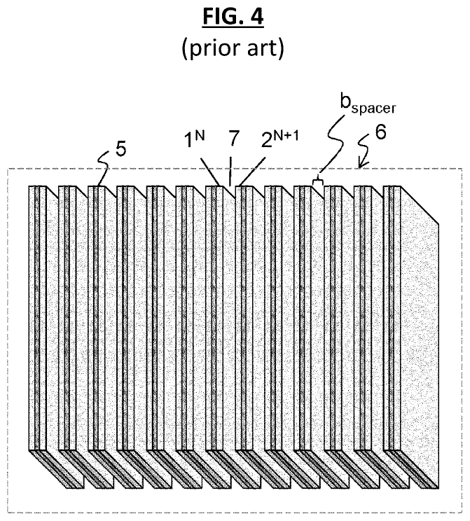

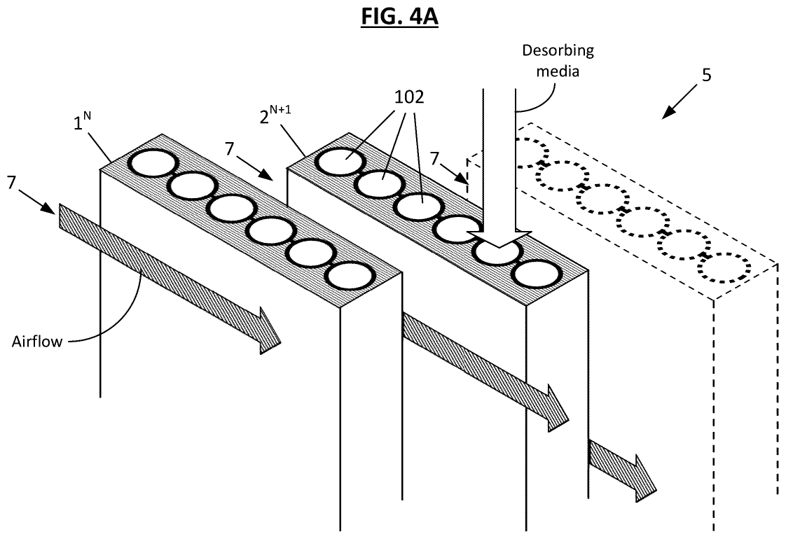

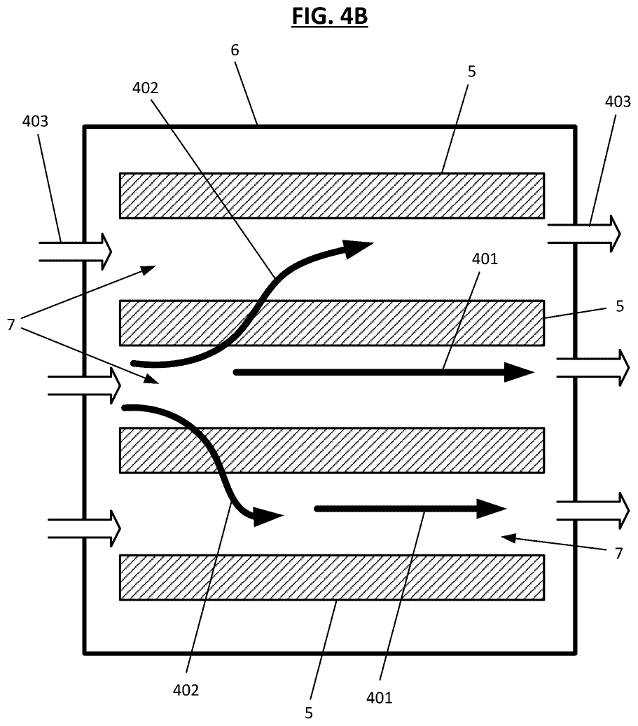

In some examples, using sorbent material in the spacer elements 4 increases the ratio of the sorbent mass to the total mass, by implementing the spacer elements 4 with adsorptive properties while maintaining the b_{spacer}, which define the air gap/parallel fluid passages or the distance between two adjacent adsorber elements. As such, the spacer elements 4 may have multiple functionalities when they are made of sorbent polymer materials in that (1) the spacer elements 4 maintains the parallel passages through the adsorber structure 6 as referred to in FIG. 4, (2) the spacer elements 4 increase the adsorptive-mass-to-total-mass ratio, and (3) the spacer elements 4 increase the density of sorbent article without changing the occupied volume of the adsorber structure 6.

In FIGS. 2D and 2E, the lumens 102 are defined by a plurality of support layer components 3a disposed proximate the sorbent layer(s) la and surrounded by the protective layer 100. The support layer components 3a may each be formed in the shape of a tube extending along substantially parallel to the sorbent layer(s) 1a. In some examples, as shown in the figures, the support layer components 3a may be formed of a substantially rigid material such that the size of the lumens 102 remain unchanged even as the surrounding sorbent layer(s) 1a are compressed in thickness, as shown by the decrease in the minimum thickness “T” of the sorbent layer(s) 1a, measured between the support layer components 3a and the protective layer 100, from FIG. 2D to FIG. 2E.

In FIG. 2F, the lumens 102 are defined by a single support layer component 3a with interconnected channels 200. That is, each lumen 102 is interconnected with at least one, or in some cases all, of the other lumens 102 via one or more interconnected channels 200 which are incorporated in the support layer component 3a but may not be visible from the outside once the support layer component 3a is sandwiched between the sorbent layer(s) 1a, for example from the viewpoint of FIGS. 2D and 2E. Therefore, the lumens 102 may be either independent of one another (that is, not connected with the other lumens 102) or interconnected via the channels 200, depending upon the configuration of the support layer component(s) 3a.

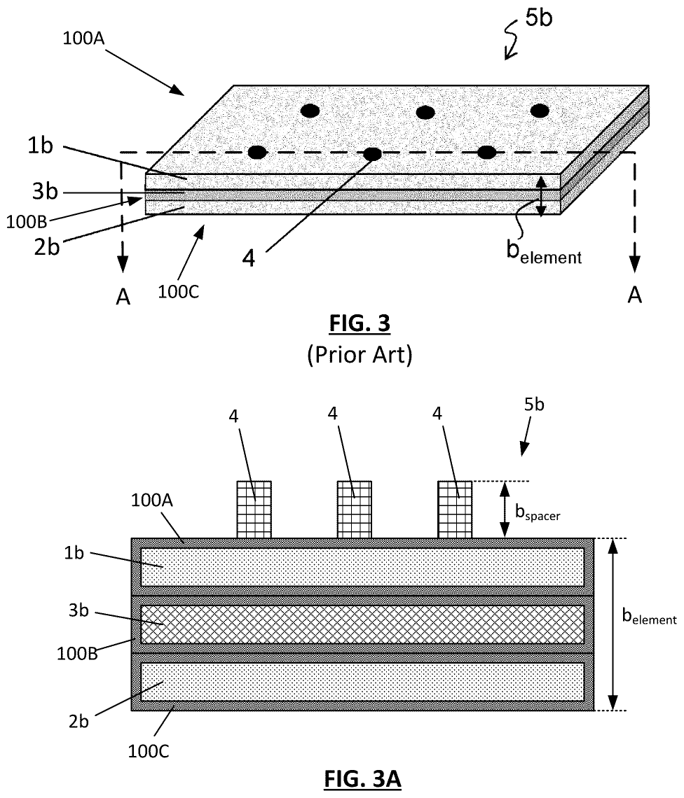

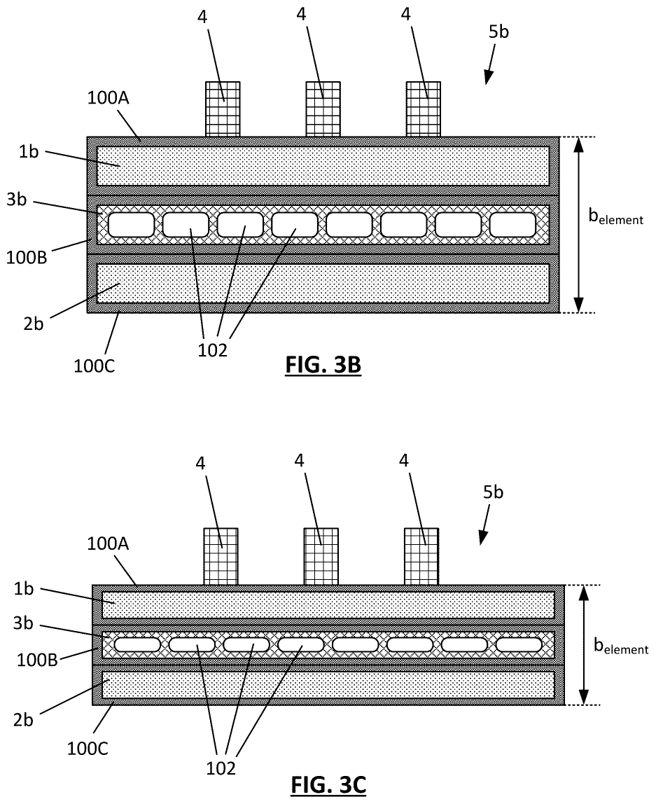

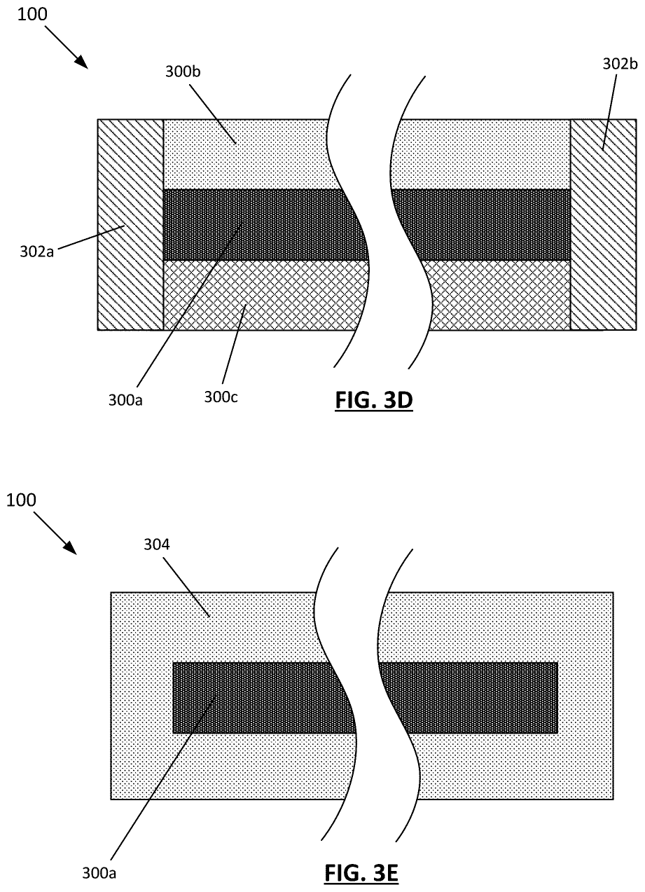

Another embodiment of the composition of the individual adsorber elements is shown in FIG. 3 of the '747 Climeworks publication. The individual adsorber element 5b comprises a layer structure with a central carrier layer 3b, adjacent to which on both sides there is provided a first sorbent layer 1b and a second sorbent layer 2b, respectively. Each individual adsorber element has a thickness bₑₗₑₘₑₙₜ, and a length L along the flow direction in adsorption. More specifically, in the embodiments used here, the individual adsorber element 5b comprises a sheet or laminate—comprising at least one layer containing a selective porous solid adsorbent for CO₂ capture and, if need be, a central porous support layer. The spacing and arrangement of multiple elements is achieved by the insertion of spacer elements 4 on one or both planar sides of the element.

In FIG. 3A of the present disclosure, the adsorber element 5b further includes a plurality of protective layers 100 (that is, 100A, 1008, and 100C as shown) in a multilayer “sandwich” configuration, where each protective layer surrounds one of the aforementioned layers (that is, the first sorbent layer 1b, the central carrier layer 3b, and the second sorbent layer 2b, respectively, as shown). The protective layers 100 are then adhered or attached to one another, such that the first sorbent layer 1b, the central carrier layer 3b, and the second sorbent layer 2b are no longer directly attached to each other, but instead are attached via their protective layers 100A, 100B, and 100C. FIGS. 3B and 3C show the central carrier layer 3b including a plurality of lumens 102 as explained above. It is to be understood that the single protective layer 100 of FIGS. 2A through 2E may be implemented to surround the first sorbent layer 1b, the central carrier layer 3b, and the second sorbent layer 2b of FIG. 3A, and likewise, the multiple protective layers 100 of FIG. 3A may be implemented to surround the sorbent layers 1a and the support layer 3a of FIGS. 2A through 2E as well.

In the above examples, the sorbent layers 1a, 1b, and 2b may include hydrophobic porous material. For example, the sorbent layers 1a, 1b, and 2b and the protective layer(s) 100 (which may also be 100A, 100B, or 100C as shown in FIGS. 3A through 3C) may include multiple layers or components of hydrophobic material(s) 300. Each layer or component of hydrophobic material(s) 300 may be referred to as a “composite region.” For example, FIG. 3D shows a first composite region 300a, a second composite region 300b, and a third composite region 300c, where the second and third regions 300b and 300c sandwich the first region 300a. The regions 300a, 300b, and 300c may have differing degrees of hydrophobicity. The hydrophobicity may be altered through various methods, such as through applying coatings or surface treatments which can include, but are not limited to, plasma etching and applying micro-topographical features. The first composite region 300a has a first hydrophobicity, the second region 300b may have a second hydrophobicity, and the third region 300c may have a third hydrophobicity. The first hydrophobicity is less than that of each the second hydrophobicity and the third hydrophobicity. The second hydrophobicity may be less than, greater than, or equal to the third hydrophobicity. The greater hydrophobicity of the second region 300b and the third region 300c may reduce the permeation of liquid water through the respective regions, thus forming a barrier between any liquid water in the surroundings and the components of the first composite region 300a. This reduces degradation of the sorbent material within the first composite region 300a that liquid water could cause, increasing the lifetime and durability of the sorbent layer and therefore also extend the lifetime and durability of the adsorber structure 6. The greater hydrophobicity of the second region 300b and the greater hydrophobicity of the third region 300c relative to the first hydrophobicity of the first composite region 300a may result from the lack of sorbent material within the second and third regions 300b and 300c, for example.

In some examples, the sorbent layer also includes end-sealing regions which are formed by applying an additional layer of a sealing material 302 onto the sorbent layer, for example the sorbent layer 1b as shown in FIG. 3D. The sealing material 302 may be the same as or different from the materials of the second region 300b and the third region 300c. For example, the sealing material 302 may be ePTFE, ePE, silicone elastomer, or any other suitable non-porous and/or hydrophobic material that protects the first composite region 300a. In other embodiments, the end-sealing region 302 may be formed by extending the second region 300b and the third region 300c and coupling (e.g., pinching, adhering) the regions 300b, 300c together. The addition of this edge sealing step will benefit the composite by protecting the sorbent(s) retained in the adsorber structure 6 and also by toughening the leading edge of the sorbent layer (which is the area most likely to incur damage from airborne debris and high-velocity strikes). In some examples, the sealing material 302 and the regions 300b, 300c may be formed from a continuous material, e.g., a tube or a sheet with end portions connected to form a closed loop, to form a seamless protective layer 304 covering region 300a as shown in FIG. 3E.

In the present disclosure, any of the protective layers and/or sealing material may be formed using PTFE or copolymers of tetrafluoroethylene (TFE) with other monomers. Such monomers may include ethylene, chlorotrifluoroethylene, or fluorinated propylenes, such as hexafluoropropylene. These monomers may be used only in very small amounts since the homopolymer may be preferred to be used for the reason that it presents the optimum crystalline/amorphous structure for the process and the products of this disclosure. Thus, amounts of the comonomers may be generally less than 0.2% and may be preferrable to use PTFE. It is to be appreciated that a wide variety of materials can be incorporated as fillers, such as carbon black, pigments of various kinds as well as inorganic materials such as mica, silica, titanium dioxide, glass, potassium titanate, and the like. Further, fluids may be used which include dielectric fluids or materials such as the polysiloxane materials shown in U.S. Pat. No. 3,278,673 assigned to W.L. Gore and Associates Inc., for example.

FIG. 4 of the '747 Climeworks publication shows how individual adsorber elements 5 are combined to form an adsorber structure 6, by arranging them as an array of parallel layers, between which there are fluid passages 7 for the passage of the air in the adsorption step, and for the steam in the desorption step, each passage bound by the sorbent layer of one adsorber element 1^{N} and another sorbent layer of the next adsorber element 2^{N+1}. The width of these flow passages is b_{spacer}.

In the individual adsorber elements 5 shown in FIG. 4A of the present disclosure, the two adjacent adsorber elements 1^{N} and 2^{N+1} each includes the plurality of lumens 102 as explained above through which desorbing media, which may be a heat-transfer fluid in a gas, vapor, or liquid form, is allowed to pass, during the desorption stage, in a direction that is different from the direction in which airflow is facilitated through the fluid passages 7, as shown. The heat-transfer fluid may be water, salt brine, any suitable glycol-based heat-transfer fluid such as ethylene glycol, a mixture of water and another suitable substance, or any other suitable type of fluid for facilitating heat transfer. As airflow is directed from one end of the fluid passages 7 to the other end, the desorbing media can be directed in a direction substantially orthogonal or perpendicular to the direction of the airflow, for example. In some examples, steam may pass through the fluid passages 7 and the desorbing media (which may be the heat-transfer fluid in liquid form) may pass through the lumens 102, respectively. In some examples, steam may be absent from the fluid passages 7 and only the desorbing media is passed through the lumens 102. In some examples, air and/or steam may pass through the fluid passages 7 along the direction of the airflow as shown.

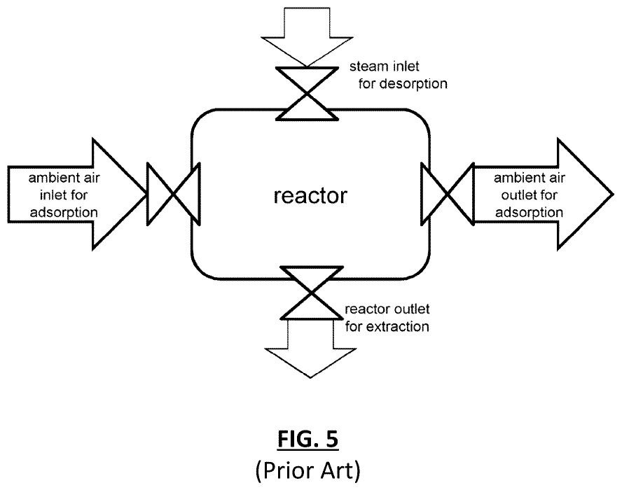

An illustration of the reactor unit and the necessary flow and inlets and outlets is schematically given by FIG. 5 of the '747 Climeworks publication. In this case, the flow of ambient air during the adsorption is along a direction orthogonal to the direction of flow of steam during the desorption. To allow that flow scheme using the layer structure of the adsorber structure the individual adsorber elements in a reactor according to this scheme need to be parallel to the paper plane.

In an embodiment 1, the adsorber structure is positioned such that the adsorber elements 5 and parallel passages 7 are orientated vertically, illustrated in FIG. 6 of the '747 Climeworks publication. In step 1, the sorbent layers are contacted with an adsorption flow a for a duration of 5 min to 40 min along a main flow direction perpendicular to the largest adsorber structure perimeter surface available, such that a through flow of air is possible along the parallel passages at a velocity of between 2 m/s to 9 m/s.

After this adsorption step 1, the reactor unit containing the adsorber structure is closed off in step 2. The pressure within the reactor unit is then reduced to a pressure between 50 mbar (abs) and 400 mbar(abs) in the evacuation step 3.

Subsequently, in the heat-up step 5 the adsorber structure is brought to a temperature between 60° C. and 110° C. by the injection of steam until the necessary reactor pressure is achieved to attain the desired adsorber structure temperature by condensation and adsorption of steam on the adsorber structure within 0.5 min to 15 min.

In the subsequent purge step 6, steam flows through the parallel passages in the same plane as the adsorption flow of step 1, either in the same flow direction or in the opposing direction (shown as d) at a velocity preferably between 0.3-1 m/s for a duration of 0.5 min to 15 min, purging the parallel passages of desorbed CO₂ in a ratio ranging from 4 to 40 moles of steam per mole of CO₂.

In a following step 7, the injection of steam is ceased and the reactor unit evacuated is to a pressure of 50-250 mbar(abs). In the final step 8, the reactor unit is opened to the ambient conditions before the cycle recommences with step 1.

An embodiment 2, is essentially embodiment 1, but the flow of steam during step 5 and step 6 is introduced, such that it can pass fully through the parallel passages in a plane orthogonal to the adsorption flow, preferably at a velocity between 1 m/s and 6 m/s. For the vertical orientation of the adsorber elements and parallel passages, this essentially entails a steam flow from top to bottom or bottom to top, as indicated in FIG. 7.

An embodiment 3, shown in FIG. 8, is essentially embodiment 1, but where the adsorber structure is positioned such that the adsorber elements and parallel passages are orientated horizontally—as indicated in FIG. 8.

An embodiment 4, is essentially embodiment 3, but the flow of steam during step 5 and step 6 is introduced, such that it can pass fully through the parallel passages in a plane orthogonal to the adsorption flow, preferably at a velocity between 1 m/s and 6 m/s. For the vertical orientation of the adsorber elements and parallel passages, this essentially entails a steam flow from left to right or right to left, as indicated in FIG. 9 of the '747 Climeworks publication.

In an embodiment 5 without evacuation, the adsorber structure is positioned such that the adsorber elements and parallel passages are orientated vertically, as illustrated in FIG. 6. In step 1, the sorbent layers are contacted with an adsorption flow a for a duration of 5 min to 40 min along a main flow direction perpendicular to the largest adsorber structure perimeter surface available, such that a through flow of air is possible along the parallel passages at a velocity of between 2 m/s to 9 m/s.

After this adsorption step 1, the reactor unit containing the adsorber structure is closed off in step 2.

Subsequently, in a steam purge step the adsorber structure is brought to a temperature between 60° C. and 110° C. by the injection of steam under ambient pressure until the local vapor pressure within the adsorber structure increases the adsorber structure temperature by condensation and adsorption of steam on the adsorber structure within 0.5 min to 30 min or 0.5-15 min, while the reactor outlet is open to allow the extraction of gases initially present after step 2 and then the extraction of CO₂ and steam. Steam flows through the parallel passages in the same plane as the adsorption flow of step 1, either in the same flow direction or in the opposing direction (shown as d) at a velocity preferably between 0.3-1 m/s for a duration of 0.5 min to 30 min or 0.5-15 min, purging the parallel passages of desorbed CO₂ in a ratio ranging from 4 to 40 moles of steam per mole of CO₂.

In the final step 8, the reactor unit is opened to the ambient conditions before the cycle recommences with step 1.

Embodiment 5 of the '747 Climeworks publication can equally be carried out using the flow conditions and adsorber structure arrangement of embodiments 2-4, again without evacuation

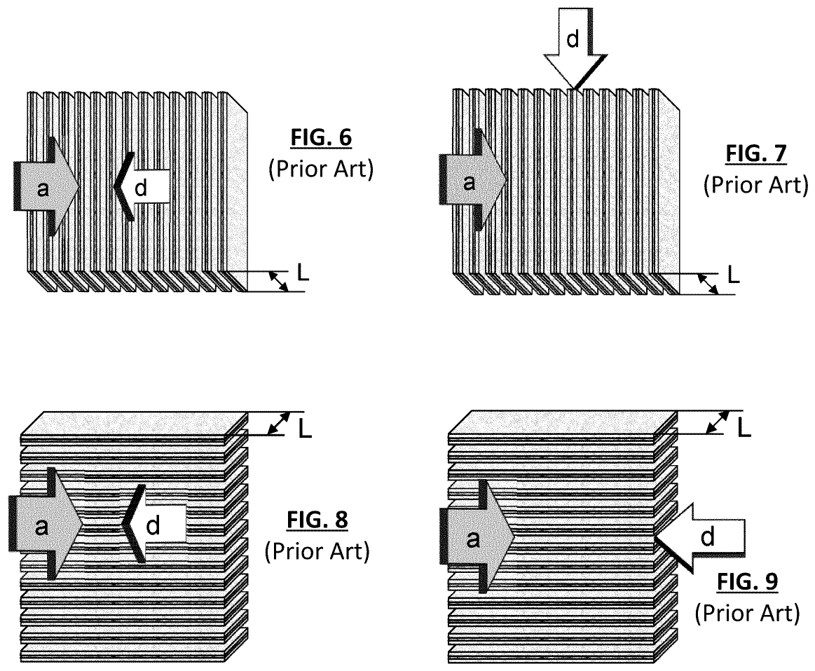

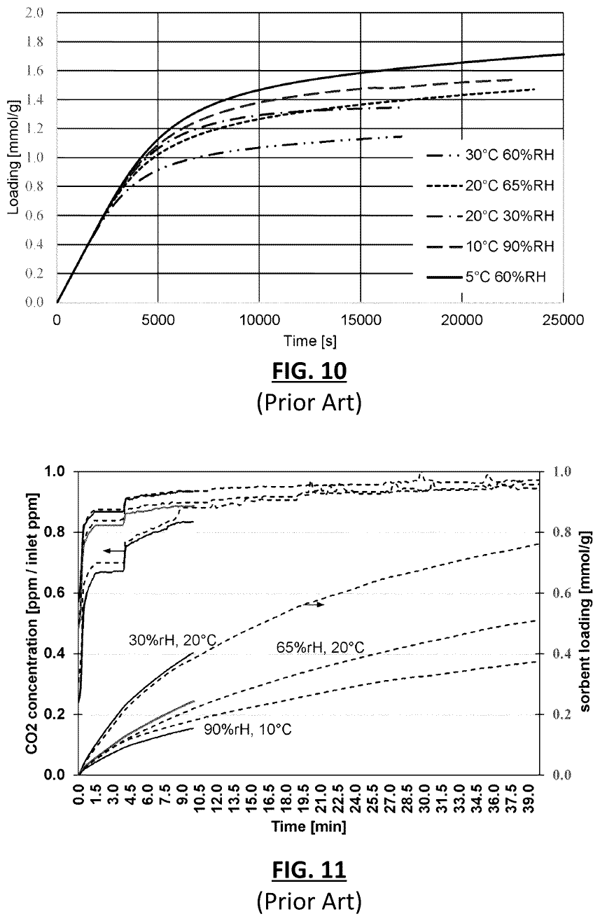

FIG. 10 of the '747 Climeworks publication shows loading curves gained from extensive hot air purge at 95° C. after adsorption at the conditions indicated on the figure on a lab-scale breakthrough analyzer and is considered to indicate the maximum potential for such an adsorber structure with current sorbent materials embedded in the first and/or second sorbent layer, reaching loadings of 1.2 to 1.6 mmol/g.

Successful operation of embodiment 1 is shown in FIG. 11 of the '747 Climeworks publication. At an adsorption through-flow velocity within the parallel passages of approximately 4 m/s an average CO₂ yield of 0.4 mmol/g was achievable within 10 min at sufficiently dry ambient conditions, increasing to 0.8 mmol/g after 40 min. The evacuation pressure for step 3 and step 7 was 150 mbar(abs), the pressure after heat-up step 5 of 2 min and during purge step 6 of 3 min lay between 850 and 950 mbar(abs). The steam flow during these steps took the same path as the initial adsorption flow, at a (mean) velocity of 0.72 m/s within the parallel passages.

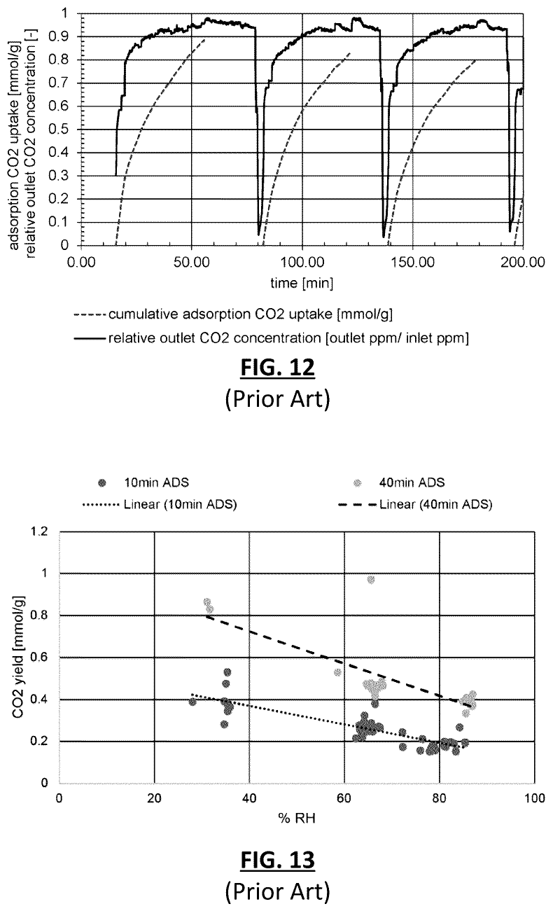

Successful operation of embodiment 5 is shown in FIG. 12 of the '747 Climeworks publication. Three cycles according to embodiment 5 were run in sequence and yielded between 0.8 and 0.9 mmol/g of CO₂.

A summary of experimental results from embodiment 1 is given in FIG. 13 of the '747 Climeworks publication, indicating successful cyclical operation over at least 10 cycles for several ambient conditions. The results are very promising and considerable improvements are expected with an optimization of the adsorber structure and sorbent material for DAC purposes.

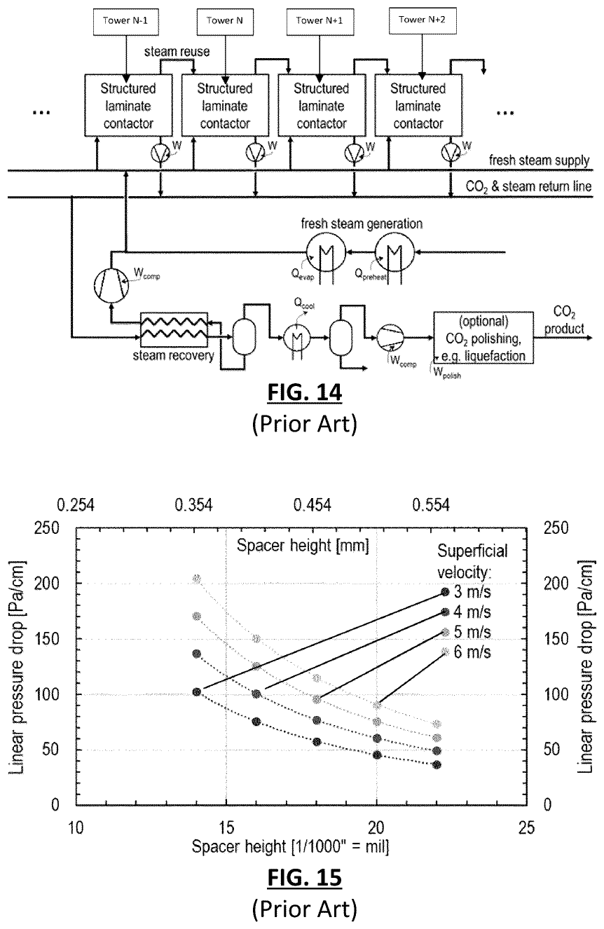

FIG. 14 of the '747 Climeworks publication shows a general scheme of a plant layout suitable and adapted for carrying out the method described.

The plant comprises T major units as required for the desired plant capacity.

Each unit comprises X subunits, where X:1 is the relation between total cycle time and the time required for desorption/regeneration. For example, in tower N there is an adsorber structure with 6 subunits, one of them is desorbing and the rest of them is adsorbing.

Each subunit comprises one or multiple reaction chambers acting in unison and undergoing the same process steps.

Each subunit can be sealed off mechanically from the surrounding ambient by way of a valve, flap or door.

Each subunit can be in size similar to a 40 foot shipping container, primarily concerning length (12.2 m) and height (2.6 m).

Each reaction chamber contains the adsorber structure, which in this case is the above laminate stack. To the extent that the inflow to the adsorber is the largest open surface provided by the subunit, therefore less than length×height (12.2 m×2.6 m).

For example, considering six reaction chambers, a viable inlet section is six adsorber structure inlets of length 1.6 m to 2 m by height 1.6 m to 2.4 m.

The volume of the adsorber structure behind this inlet for the entire subunit ranges from 1.5 m³ (1.6 m×1.6 m×6×0.1 m) to 60 m³ (just more than 2 m×2.4 m×6×2 m).

The adsorber structure mass of one subunit is in the range 75 kg to 3000 kg, depending on the optimal configuration.

Each subunit is supplied with steam in the range of 6 tons to 20 tons per hour.

An adsorption airflow can be generated at each subunit of 100,000 m³/h to 650,000 m³/h.

### Specific Example 1 of the '747 Climeworks Publication:

The results shown in FIGS. 11, 12 and 13 were obtained on an experimental rig in April and May of 2020. The adsorber structure was operated as given in embodiment 1 and FIG. 6, with dimensions of 360 mm×360 mm×100 mm, where the gas flow inlet and outlet was the respective largest surface given by the 360 mm by 360 mm area. The adsorber elements comprised at least one layer of functionalized silica for CO₂ adsorption, and had a width of approximately 0.25 mm. The spacer employed provided a spacing between parallel adsorber elements of approximately 0.5 mm. The entire adsorber structure consisted therefore of approximately 480 individual adsorber elements.

The operational embodiment with results shown in FIG. 11 employed an adsorption step 1 with duration of 10 min and 40 min and flow velocity within the parallel passages of 4 m/s. In step 2 and 3, the reactor unit was isolated and evacuated to 150 mbar(abs). In the heat up step 5, steam injection increased chamber pressure to 950 mbar(abs) within less than 2 min, before a steam purge step 6 with flow velocities in the channel of 0.72 m/s at a pressure of 850 mbar(abs) is conducted for 3 min. In step 7, the injection of steam is ceased and the pressure in the reactor unit is reduced to 150 mbar(abs). Before the unit is re pressurized to ambient in step 8.

The operational embodiment with results shown in FIG. 11 employed an adsorption step 1 with duration of 40 min and flow velocity within the parallel passages of 4 m/s. In step 2, the reactor unit was isolated but no evacuation occurred. No dedicated heat-up step was foreseen; instead, an immediate steam purge step 6 with flow velocities in the channel of 0.72 m/s at ambient pressure is conducted for 6 min resulting in simultaneous heat-up and purge of the adsorber structure. The injection of steam is ceased and the isolation of the unit broken before the unit again recommences with adsorption.

As pointed out above, the pressure drop across such an adsorber structure can be estimated by the following equation:

$$\frac{Δ P}{L} = K ( {U}_{inlet} ) \cdot {( {b}_{spacer} )}^{- 2.27} \qquad ( Equation 4 )$$

Here:
ΔP is the pressure drop across the structure in Pa.
L is the length of the parallel passage the gas flows across in cm.
K is a roughness factor to be determined experimentally, typically in the range of 1 to 10.
Uᵢₙₗₑₜ is the velocity on the inlet plane of the adsorber structure (not yet the velocity in the parallel passage) in m/s.
b_{spacer} is the height of the spacers determining the width of the parallel passages in mm.

FIG. 15 indicates such pressure drop calculated for various spacer heights and superficial velocities.

An exemplary configuration for flue gas capture entails a system with length of 2 m, and spacing of 0.35 mm at a superficial velocity of 5 m/s. Such a configuration results in a pressure drop of well above 3 bar. Such a pressure drop might be feasible for flue gas system operating at elevated pressures, but not for DAC applications.

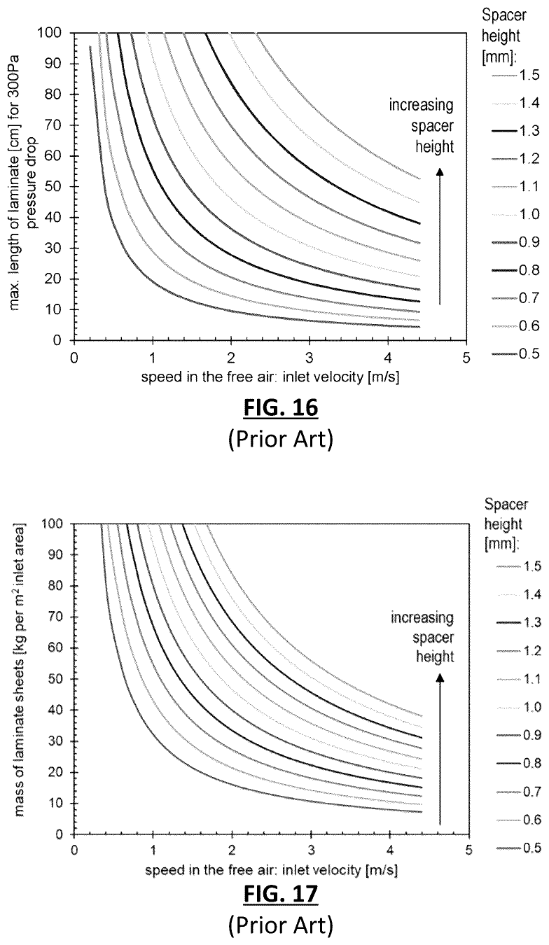

DAC applications are generally limited by the viable pressure drop of commercially available fan and ventilator systems. For axial fans, this leads to a maximum pressure drop around 300 Pa is substantial volume flows are still to be achieved, and for radial fans this can be increased to 600 Pa or 700 Pa, at most up to 1200 Pa. Using this correlation, a map of the maximum flow path and therefore laminate length can be determined for a given adsorber type and spacer height as a function of the inlet flow velocity, also termed the superficial velocity, or velocity in free air to achieve a target pressure drop across the adsorber, see FIG. 16.

Given this length of the adsorber structure, the thickness and density of individual adsorber sheets as well as the height of the spacers, a mass of adsorber structure per inlet area can be determined (see also FIG. 17):

$$\frac{m}{A} = L \cdot {ρ}_{element} \cdot \frac{{b}_{e l e m e n t}}{{b}_{e l e m e n t} + {b}_{spacer}} \qquad ( Equation 5 )$$

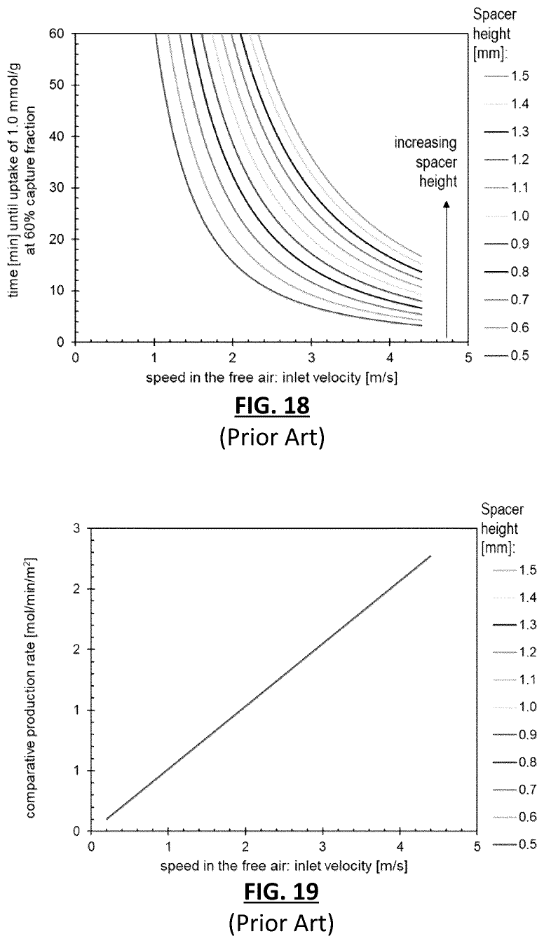

Additionally, by knowing the flow and assuming a capture fraction, that is portion of the total CO₂ passing the contactor that is captured, in this case 60%, a time until a certain loading of the sorbent is achieved can be estimated (see also FIG. 18).

The ratio of the mass of adsorber structure and achieved CO₂ loading per unit area divided by the time required for adsorption is an indicative and directly comparative parameter for the CO₂ production rate, see FIG. 19.

This is the same for all spacer heights, as it is assuming a constant capture fraction for the ingoing air, and therefore linearly increases with velocity. This assumption would be verified or adjusted once specific kinetic and geometric parameters of the sorbent and structure are known. Another parameter is required to adjudge which spacer height to best use for such a system. This can be achieved by analyzing the kinetics involved in the adsorption process. This is done by comparing a characteristic time of advection T_{adv}—which describes the time frames associated with the flow—with a characteristic time of diffusion T_{diff}—which describes the time frames associated with the diffusion of CO₂ into the sorbent layer.

Here

$${τ}_{adv} = \frac{L}{{U}_{interstitial}} = \frac{L}{{U}_{inlet}} \cdot \frac{{b}_{spacer}}{{b}_{e l e ment} + {b}_{spacer}} \qquad ( Equation 6 )$$

and the characteristic time of diffusion is the sum of the characteristic time of film diffusion and pore diffusion into the adsorptive layer:

τ_{diff}=τ_{film}+τₚₒᵣₑ (Equation 7)

where the characteristic time of film diffusion is given as a function of the spacer height and the film mass transfer coefficient k_{f}:

$${τ}_{film} = \frac{{b}_{spacer} / 2}{{k}_{f}} \qquad ( Equation 8 )$$

The characteristic time of pore diffusion is given as a function of the element thickness and the pore mass transfer coefficient kₚ:

$${τ}_{p} = \frac{{b}_{e l e m e n t} / 2}{{k}_{p}} \qquad ( Equation 9 )$$

With these correlations, an analysis of the ratio of advection to diffusion characteristic times can be carried out, as shown in FIG. 20.

The important aspect here is, that larger spacing solutions, that are in this case still attributed to the length assigned to maintain a desired pressure drop, show a smaller advection to diffusion time ratio, indicating more time for diffusion compared to smaller spacer heights associated with shorter beds. The efficiency of the capture process during adsorption is largely determined and limited by diffusion into the sorbent.

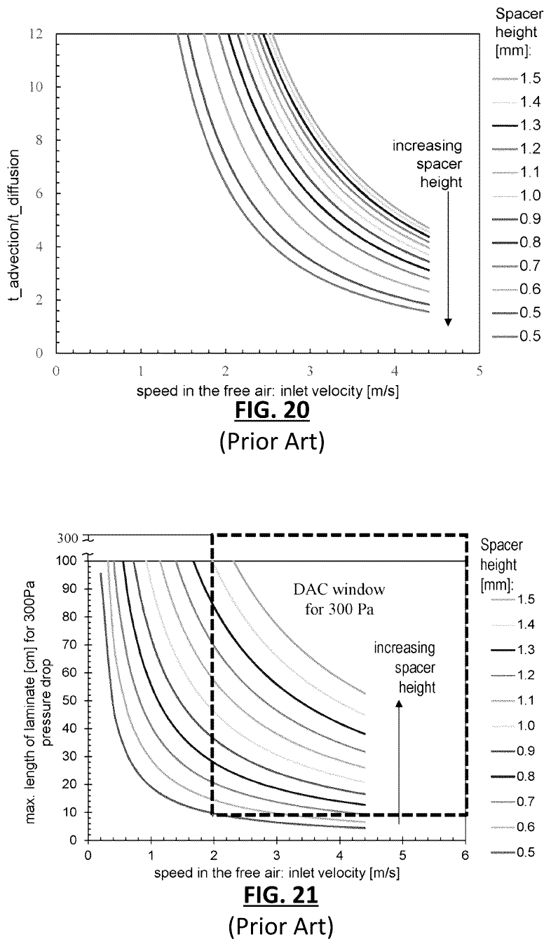

Therefore, the above realization shows for DAC, that larger spacer heights and longer beds are producing better adsorption results than a theoretically similar solution with tighter spacing and shorter beds. Therefore, DAC applications (see FIG. 21) are optimally operated at larger spacer heights, the technically feasible range seemingly between 0.4 and 3 mm, and technically realizable inlet velocities of 2-6 m/s, resulting in bed lengths of 100 to 3000 mm. At this stage, another factor to be considered beside the practical and technical implementation is to be mentioned—the cost of such adsorber structures: larger spacing structures inherently require more initial sorbent material and the increased investment cost drives the trade-off from the other direction in most practical implementations.

### Specific Example 2 of the '747 Climeworks Publication:

An adsorber structure based on parallel passages from which the maximum capture capacity is sought must consider a number of factors: allowable pressure drop, sorbent capacity, effective sorbent density and kinetics of capture. A sorbent for example having high capacity requires a lot of air to fully load which correspondingly requires wide channels to respect the pressure drop limitation. Correspondingly, such systems will have likely lower sorbent density limiting the potential capture capacity.

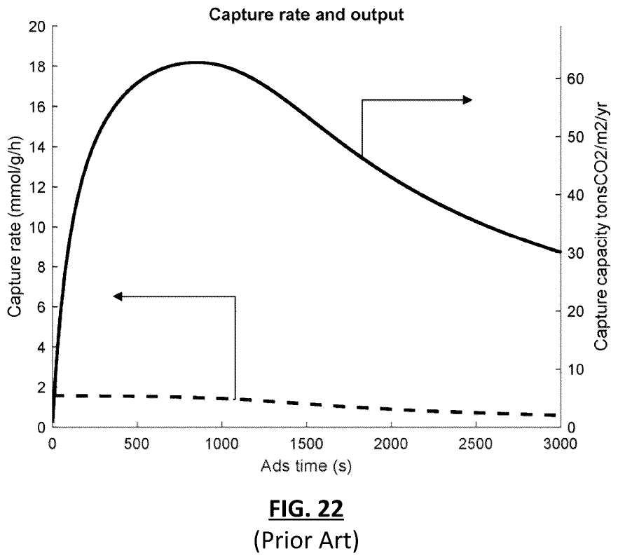

In this example associated with FIG. 22, the operation of an adsorber structure along the disclosure of the '747 Climeworks publication is numerically investigated fora direct air capture process with a particular sorbent and adsorber structure. A limiting pressure drop of 750 Pa is assumed acceptable for a specific sorbent material having a surface density of 230 g/m ², a parallel passage spacing width b_{spacer} of 1 7 mm, an inflow air speed of 7 m/s in the passages and a length L of 1 2 m. The capture process was numerically simulated with a linear driving force model and mass transfer formulations for CO₂ air and the optimum capture capacity was determined (in tons CO₂ capture/m ² inlet air/yr) by varying the adsorption duration with an associated desorption process duration. It is seen that the optimum adsorption process duration for this case can be found at 840 s (14 min) and corresponds to an average capture rate of just under 2 mmol/g/h. This point falls well within the ranges of interest specified in the '747 Climeworks publication.

Also disclosed herein are methods for removing gaseous carbon dioxide (CO₂) from the atmosphere using any suitable means, methods, processes, or devices for atmospheric CO₂ removal as disclosed herein. In some examples, a carbon dioxide removal service provider that may be a person, a device, an atmospheric processing facility, a carbon dioxide removal plant, software, an internet site, an electronic interface, an organization, or a corporate agent or entity (that may include a control center, a headquarters, a data management center, an intermediary data collection or processing center, or facilitating organizations that provide information and/or control functions for or services to the provider) or an electronic device or display associated with or accessible to the provider may receive and/or become aware of information about a dispersion of a first quantity of gaseous CO₂ in the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. In some examples, the information may be in the form of an electronic communication (e.g., first electronic communication) that includes information about the dispersion of the first quantity of gaseous CO₂ into the atmosphere at the first location that may be received from and/or provided to a computing and/or electronic display device.

The carbon dioxide removal service provider may initiate an immediate or subsequent separating of or a method of separating a second quantity of gaseous CO₂ at a second location which may be different from the first location. The second location may be located remote to the first location such as, for example, when the first location is in a populated commercial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be initiated by the sending or transmitting of instructions or confirmation to a location that has the capability of performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may initiate a reporting of data regarding the second quantity that will be, is being, or has been removed from the atmosphere. The initiating may be initial steps taken to start an immediate or subsequent reporting of data that may be performed via any suitable means of electronic communication or data transmission which may be wired or wireless. In some examples, the reporting may involve the preparing of information to be included in such reporting or later reporting and the subsequent sending or transmitting of instructions or confirmation to another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may receive and/or become aware of information about a first quantity of gaseous CO₂ which may include a dispersion of gaseous CO₂. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. Such quantity may represent the amount of gaseous CO₂ being dispersed at a location (e.g., in tons of CO₂) and/or the rate of dispersion (e.g., in tons of CO₂ per minute, hour, day, etc.). In some examples, the information may be received as an electronic communication from another entity or device which sends or transmits instructions concerning gaseous CO₂ removal as disclosed herein. In some examples, an electronic communication (e.g., first electronic communication) that includes information about the dispersion of the first quantity of gaseous CO₂ that may be received from and/or provided to a computing and/or electronic display device.

The carbon dioxide removal service provider may separate or begin separation of a second quantity of gaseous CO₂ from the atmosphere, where the second quantity is at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. In some examples, the separating may be performed by a carbon capture device capable of carrying out any method for separating gaseous CO₂ from a gas mixture in the form of ambient air, as disclosed herein.

The carbon dioxide removal service provider may report the data regarding the second quantity that will be, is being, or has been removed from the atmosphere. The reporting of data may be performed via any suitable means of electronic communication or data transmission which may be wired or wireless. In some examples, the reporting may be in response to receiving instructions or confirmation as transmitted from another entity or device which has the capability of starting or fully performing such reporting. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication may be transmitted to the computing or display device. In some examples, the second electronic communication may be transmitted to an additional computing or display device that may be separate or different from the aforementioned computing or display device.

In some examples, the method for removing gaseous CO₂ from the atmosphere may involve a carbon dioxide removal service provider (as described above) that may transmit, emit, or send out information about a dispersion of a first quantity of gaseous CO₂ into the atmosphere at a first location. The information may be complete, partial, derivative, or a summary and may be received in the form of an electronic display, an electronic alert, a notification, or other electronic communication (e.g., an email message, a telephone call, or a video call) and may include digital data representing the amount of gaseous CO₂ being dispersed at the first location (e.g., in tons of CO₂) and/or the rate of dispersion (e.g., in tons of CO₂ per minute, hour, day, etc.) as well as the data associated with the first location, such as a name of the city and/or country, GPS location, weather information, etc. The transmitting may be an emitting and/or a sending out performed via any suitable means of electronic communication or data transmission which may be wired or wireless that may not be received by the intended recipient or any recipient. In some examples, the information may be in the form of an electronic communication (e.g., first electronic communication) that includes information about the dispersion of the first quantity of gaseous CO₂ into the atmosphere at the first location that may be transmitted, emitted, and/or sent out to a computing device with such transmission, emitting, and/or sending out not necessarily being received by any recipient.

The carbon dioxide removal service provider may request an immediate or subsequent separating of or a method of separating a second quantity of gaseous CO₂ from the atmosphere at a second location. The second location may be located remote to the first location such as, for example, when the first location is in a populated commercial or industrial area and the second location is near a geothermal or other hazardous energy source that powers the separating process at the second location. The second quantity may be at least a portion of the first quantity such as from 0% to 10%, from 10% to 20%, from 20% to 30%, from 30% to 40%, from 40% to 50%, from 50% to 60%, from 60% to 70%, from 70% to 80%, from 80% to 90%, from 90% to 100%, or any other suitable value, combination, or range therebetween. The second quantity may be a portion of the first quantity or the entirety of the first quantity, and the second quantity may be associated with a partial delivery of a carbon removal service involving multiple separating cycles. The separating may include any suitable method or process as disclosed herein or the use of any suitable device as disclosed herein. The requesting of the separating or an initiation of the separating may be performed via any suitable means of electronic communication or data transmission which may be wired or wireless. In some examples, the requesting may be by sending, emitting, or transmitting of instructions to a start command to a location that has the capability of starting or fully performing such separating. In some examples, the separating may be performed by a carbon capture device capable of carrying out any method for separating gaseous CO₂ from a gas mixture in the form of ambient air, as disclosed herein. In some examples, the distance from the first location to the second location may be from 100 km to 200 km, from 200 km to 500 km, from 500 km to 800 km, from 800 km to 1000 km, from 1000 km to 2000 km, from 2000 km to 3000 km, from 3000 km to 4000 km, from 4000 km to 5000 km, from 5000 km to 6000 km, from 6000 km to 7000 km, from 7000 km to 8000 km, from 8000 km to 9000 km, from 9000 km to 10,000 km, from 10,000 km to 15,000 km, from 15,000 km to 20,000 km, or any other suitable value or range therebetween.

The carbon dioxide removal service provider may receive a reporting, an indication of such reporting, and/or an indication of an availability of data regarding the second quantity that will be, is being, or has been removed from the atmosphere. The receiving of the reporting does not require examination or review by a human, may be achieved by simply making the reporting accessible even if subsequently never reviewed or acknowledged, and/or may be performed via any suitable means of electronic communication or data transmission which may be wired or wireless. In some examples, the receiving of the reporting may regard the second quantity, such as how much of the gaseous CO₂ was separated within a predetermined amount of time, for example within a day, a week, a month, etc. The reported data may be associated with the carbon capture device as disclosed herein regarding the second quantity. For example, the carbon capture device may generate or provide data associated with the separating of the second quantity of gaseous CO₂, which may be obtained from the carbon capture device directly or indirectly (e.g., via an intermediary entity or device). In examples, at least a part of the data generated by the carbon capture device is provided in an electronic communication. As another example, the data may be summarized or otherwise processed, such that an indication of the data is provided in an electronic communication (e.g., second electronic communication). In some examples, the second electronic communication is received from the computing device. In some examples, the second electronic communication is received in response to the transmitting of the first electronic communication. In some examples, the second electronic communication is received from the computing or display device in response to the transmitting of the first electronic communication to the computing or display device.

As used herein, “receiving” information is to be understood as an act of “receiving” which requires only one party (or entity, device, etc.) to perform, such that a separate party for performing the act of “sending” is not required.

As used herein, “initiating” a separating (or a method of separating) is to be understood as an act of “initiating” that includes an initial or completed act of preparing or dispatching instructions to another party or device with the intent that there is an execution or start of a separating process or the association of an already started separating process with the initiating step. For example, the act of “initiating” the separating of gaseous CO₂ may cause a carbon capture device to subsequently receive an instruction, either directly or indirectly (e.g., via intermediary entities or devices) to initiate the separating, in response to which the carbon capture device operates accordingly. In another example, the act of “initiating” a separating (or a method of separating) gaseous CO₂ may include a carbon dioxide removal service provider associating carbon dioxide that has already been removed from the atmosphere (or presently in an active removal process) with a subsequent initiating of a separating. It will be appreciated that the instruction received by the carbon capture device need not be provided as part of such an “initiating” operation. Further, the act of “separating” of the CO₂, for example, is therefore not necessarily part of the act of “initiating” such separating, such as when the “initiating” of the separating is performed by a first party and the subsequent “separating” itself is performed by a second party different from the first party. Furthermore, the act of “separating” does not need to be accomplished or fully completed, either by the first party or the second party. It will also be appreciated that the act of initiating can be fully performed in one jurisdiction or country even though an acknowledgement of the initiating or an act subsequent to or associated with the initiating takes place in a different jurisdiction or country.

As used herein, “initiating” a reporting (e.g., of data) is to be understood as an act of “initiating” that includes the initial or complete act of preparing or dispatching instructions to another party to prepare, start, or complete the reporting at a later time. The act of “reporting” any data, for example, is therefore not necessarily part of the act of “initiating” such reporting, such as when the “initiating” of the reporting is performed by a first party (the initiating party) and the “reporting” itself is performed by a second party (the reporting party) different from the first party (the initiating party). Furthermore, the act of “reporting” does not need to be accomplished or fully completed, either by the first party or the second party. It will be appreciated that the act of initiating can be fully performed in one jurisdiction or country even though an acknowledgement of the initiating or an act subsequent to or associated with the initiating takes place in a different jurisdiction or country.

As used herein, “reporting” data is to be understood as an act of “reporting” which may require only one party (reporting party) to perform. Furthermore, the act of “reporting” does not require the receipt (or confirmation of receipt) of such reporting by another party (receiving party). The reporting may be a storage of the data or display of the data at a location that is accessible to an intended recipient, and may still be considered to be a reporting even when the intended recipient does not access or review the data.

As used herein, “transmitting” information is to be understood as an act of “transmitting” which may require only one party (the transmitting party) to perform. Furthermore, the act of “transmitting” does not require a receiver (e.g., receiving party) or receipt (e.g., confirmation of receipt) of the information that is transmitted.

As used herein, “requesting” a separating (or initiation of a method of separating) is to be understood as an act of “requesting” which may require only one party (the requesting party) to perform. Also, the act of “separating” which is requested by the act of “requesting” may be performed by another party (the separating party). Furthermore, the act of “requesting” may be only intended or started and does not need to be accomplished or fully completed (e.g., when no separating results from the act of “requesting” such separating). In an example, the act of “requesting” a separating (or initiation of a method of separating) of gaseous CO₂ may include a carbon dioxide removal service provider associating carbon dioxide that has already been removed from the atmosphere (or presently in an active removal process) with a subsequent request for a separating. It will be appreciated that the act of requesting can be fully performed in one jurisdiction or country even though an acknowledgement of the requesting or an act subsequent to or associated with the requesting takes place in a different jurisdiction or country.

As used herein, “receiving” a reporting or an indication of the reporting is to be understood as an act of “receiving” which does not require a sender (e.g., sending party). The receiving may be a storage of the data or display of the data at a location that is accessible to an intended recipient, and may still be considered to be a receiving even when the intended recipient does not access or review the data.

As can be appreciated, the first quantity, the second quantity, and the portion of the first quantity may be estimated or projected values. It can be further appreciated that carbon dioxide gas released or dispersed at the first location may not necessarily include or be the same CO₂ molecules separated or collected at the second location, and that the second quality may be an equivalent quantity of CO₂ that was released or dispersed. The CO₂ in the portion of the first quantity may be in a non-gaseous form. The portion of the first quantity or the second quantity may refer to carbon dioxide that is entrapped in the sorbent as disclosed herein or that has been stored or otherwise converted into another form. The portion of the first quantity or the second quantity may also include gases other than carbon dioxide. For example, the second quantity may be in a non-gaseous form or combined with other materials.

As used herein, a “carbon capture device” refers to any one or more devices as disclosed herein that is capable of separating gaseous CO₂ from the atmosphere at the location at which the device is installed or located. The carbon capture device may refer to a single device or a plurality of devices, or a facility containing therein one or more such devices or component devices that act in concert. The device may include, for example, the desorbing media source(s) and the adsorber structure(s) as disclosed herein. The device may be operable by a user or operator using an electronic device. The device may generate data associated with its operation, for example as may be detected by one or more sensors and/or as may include log data, among other examples.

As used herein, an “electronic device” is capable of performing one or more electronic operations, for example a computer, smartphone, smart tablet, etc. The electronic device may include for example a display device and/or one or more processing units and one or more memory units. The processing unit may include a central processing unit (CPU), a microprocessor, system on a chip (SoC), or any other processor capable of performing such operations. The memory unit may by a non-transitory computer-readable storage medium storing one or more programs or instructions thereon which, when run on the processing unit, causes the processing unit or the electronic device to perform one or more methods as disclosed herein. The memory unit may include one or more memory chips capable of storing data and allowing storage location to be accessed by the processing unit(s), for example a volatile or non-volatile memory, static or dynamic random-access memory, or any variant thereof. In some examples, the electronic device may be referred to as a computing device.

Technical advantages of removing gaseous CO₂ from an atmosphere using the methods or processes as disclosed herein includes, but are not limited to, facilitating a network of entities and/or devices that are capable of communicating with other entities and/or devices in order to remotely provide instructions or facilitating separation and removal of gaseous CO₂ without requiring to be physically at the location to do so. Furthermore, the methods and processes as disclosed herein provide a robust network of interinstitutional communication such that each entity (which may be an institution associated with a physical location) is capable of directing or initiating the separation and removal of gaseous CO₂ at multiple locations simultaneously, as well as having the capability of flexibly changing the location at which separation and removal of gaseous CO₂ is determined to be removed. The change in location may be performed at or near real-time such that there is minimal time lag between when the instructions are provided and when the separating of gaseous CO₂ takes place at the designated location, for example. In some examples, the methods or processes as disclosed herein provides a flexible communication network in which the entity or device which performs the separation and removal of gaseous CO₂ at the designated location may provide a timely reporting (e.g., operation summary and/or invoice for the service rendered) associated with the amount of gaseous CO₂ that was removed during a predetermined time period. Such reporting may be generated automatically or manually, may be generated at a predetermined time interval (e.g., once every day, week, month, etc.) or more flexibly as manually determined (e.g., each time a user or entity requests), or may be generated in response to achieving or exceeding a predetermined threshold, including but not limited to the amount of gaseous CO₂ that was separated and removed from the atmosphere (e.g., every 1 ton, 5 tons, 10 tons, etc., of gaseous CO₂ that was removed from the atmosphere), and any other suitable conditions as determined and agreed upon by the entities involved, for example.

### LIST OF REFERENCE SIGNS

1—first sorbent layer
2—second sorbent layer
3a—porous support layer
3b—carrier layer
4—spacer elements
5—individual adsorber element
6—complete adsorber structure
7—fluid passage, bound on one side by a first sorbent layer (1^{N}) from one adsorber element, and a second sorbent layer (2^{N+1}) from a neighboring adsorber element
100—protective layer
102—lumens
200—channels
300—hydrophobic material or composite region
302—sealing material
304—seamless protective layer
401—first type of flow-through
402—second type of flow-through
403—third type of flow-through
A—inlet area
a—flow direction of the multi-component flow during adsorption
bₑₗₑₘₑₙₜ—element thickness of the adsorber element
b_{spacer}—spacing width
d—flow direction of the steam flow during desorption
ΔP—pressure drop across the adsorber structure
K_{surface}—roughness factors
Kₗᵢₙₑₐᵣ—linear roughness factors
kₜ—film mass transfer coefficient
kₚ—pore mass transfer coefficient
L—length of the adsorber element along the flow-through direction in adsorption
m—mass of the adsorber structure
Pₑₗₑₘₑₙₜ—density of individual adsorber sheets
T_{adv}—characteristic time of advection
T_{diff}—characteristic time of diffusion
T_{film}—characteristic time of film diffusion
Tₚₒᵣₑ—characteristic time of pore diffusion
Uᵢₙₗₑₜ—velocity on the inlet plane of
Uᵢₙₜₑᵣₛₜᵢₜᵢₐₗ—velocity between the plates in the channels.

What is claimed is:

1. A method for separating gaseous carbon dioxide from ambient atmospheric air, containing said gaseous carbon dioxide as well as further gases different from gaseous carbon dioxide, by cyclic adsorption/desorption using a sorbent material adsorbing said gaseous carbon dioxide,
using a unit containing an adsorber structure with said sorbent material, the adsorber structure being able to sustain a temperature of at least 60° C. for the desorption of at least said gaseous carbon dioxide and the unit being openable to flow-through of the ambient atmospheric air and for contacting it with the sorbent material for the adsorption step,
wherein the adsorber structure comprises an array of individual adsorber elements, each adsorber element comprising at least one support layer, at least one sorbent layer comprising at least one sorbent material, and at least one protective layer comprising a microporous material disposed around the support layer and the sorbent layer, where said sorbent material offers selective adsorption of CO₂ over other major non-condensable gases in air in the presence of moisture or water vapor, and wherein the protective layer has greater hydrophobicity than the sorbent material,
wherein the adsorber elements in the array are arranged essentially parallel to each other and spaced apart from each other forming parallel fluid passages for flow-through of at least one of ambient atmospheric air and desorbing media, wherein the method comprises at least the following sequential and in this sequence repeating steps (a)-(e):
(a) contacting said ambient atmospheric air with the sorbent material to allow at least said gaseous carbon dioxide to adsorb on the sorbent material by flow-through through said parallel fluid passages under ambient atmospheric pressure conditions and ambient atmospheric temperature conditions in an adsorption step;
(b) isolating said sorbent with adsorbed carbon dioxide in said unit from said flow through while maintaining the temperature in the sorbent;
(c) injecting a stream of desorbing media and thereby inducing an increase of the temperature of the sorbent to a temperature between 60 and 110° C., starting the desorption of CO₂;
(d) extracting at least the desorbed gaseous carbon dioxide from the unit and separating gaseous carbon dioxide from the desorbing media by condensation in or downstream of the unit, while still contacting the sorbent material with the desorbing media by injecting and/or partially circulating the desorbing media into said unit, thereby flushing and purging both the desorbing media and CO₂ from the unit at a molar ratio of the desorbing media to carbon dioxide between 4:1 and 40:1, while regulating the extraction and desorbing media supply or both to essentially maintain the temperature in the sorbent at the end of the preceding step (c) or to essentially maintain the pressure in the sorbent at the end of the preceding step (c), or both;
(e) bringing the sorbent material to ambient atmospheric temperature conditions;
wherein in step (a) the flow speed of the ambient atmospheric air through the adsorber structure is inclusively within the range of 2-9 m/s, and
wherein at least in step (d) the flow speed of the desorbing media through the adsorber structure is at least 0.2 m/s,
wherein essentially exclusive use or fully exclusive use of the desorbing media is made in steps (c) and (d) for the delivery of heating energy during the desorption process.

2. The method according to claim 1, wherein in step (a) the flow speed of the ambient atmospheric air through the adsorber structure is in the range of 2-9 m/s,
or wherein at least in step (d) the flow speed of the desorbing media through the adsorber structure is in the range of 0.3-6 m/s.

3. The method according to claim 1, wherein in step (a) the specific flow rate of the ambient atmospheric air through the adsorber structure, as a function of the mass of the sorbent, is inclusively within the range of 20-10,000 m³/h/kg,
or wherein in step (a) the specific flow rate of the ambient atmospheric air through the adsorber structure, as a function of the volume of the sorbent, is inclusively within the range of 4,000-500,000 m³/h/m ³,
or wherein at least in step (d) the specific flow rate of the desorbing media through the adsorber structure, as a function of the mass of the sorbent, is inclusively within the range of 1-500 kg/h/kg,
or wherein at least in step (d) the specific flow rate of the desorbing media through the adsorber structure, as a function of the volume of the sorbent, is inclusively within the range of 200-15,000 kg/h/m ³.

4. The method according to claim 1, wherein the carbon dioxide capture fraction, defined as the percentage of carbon dioxide captured from the ambient atmospheric air in an adsorption step by the sorbent material is inclusively within the range of 10-75%,
or wherein the amount of carbon dioxide captured on the sorbent per gram sorbent is at least 0.1 for an adsorption time span of at least 5 minutes or at least 10 minutes,
or wherein the normalized amount of carbon dioxide captured on the sorbent per gram sorbent per hour is inclusively within the range of 0.5-10 mmol/g/h.

5. The method according to claim 1, wherein the adsorber structure comprises an array of individual adsorber elements, each adsorber element comprising a central carrier layer or porous support and on both sides thereof at least one porous or permeable sorbent layer with chemically attached carbon dioxide capture moieties.

6. The method according to claim 1, wherein the adsorber elements in the array are arranged essentially parallel to each other and spaced apart by spacer elements from each other forming parallel fluid passages for flow-through of at least one of ambient atmospheric air and desorbing media, wherein the spacer elements comprise a sorbent material configured to facilitate adsorption and desorption through the spacer elements,
or wherein the spacing (b_{spacer}) between the adsorber elements is inclusively within the range of 0.2-5 mm,
or wherein each adsorber element has the form of a plane with a thickness (bₑₗₑₘₑₙₜ) inclusively within the range of 0.1-1 mm.

7. The method according to claim 1, wherein said unit is evacuable to a vacuum pressure of 400 mbar(abs) or less, and wherein step (b) includes isolating said sorbent with adsorbed carbon dioxide in said unit from said flow-through while maintaining the temperature in the sorbent and then evacuating said unit to a pressure inclusively within the range of 20-400 mbar(abs), wherein in step (c) injecting a stream of desorbing media is also inducing an increase in internal pressure of the reactor unit, and wherein step (e) includes bringing the sorbent material to ambient atmospheric pressure conditions and ambient atmospheric temperature conditions.

8. A device for carrying out a method for separating gaseous carbon dioxide from a gas mixture in the form of ambient air, containing said gaseous carbon dioxide as well as further gases different from gaseous carbon dioxide by cyclic adsorption/desorption using a sorbent material adsorbing said gaseous carbon dioxide,
said device comprising a desorbing media source;
at least one unit containing an adsorber structure with said sorbent material, the adsorber structure being heatable to a temperature of at least 60° C. for the desorption of at least said gaseous carbon dioxide and the unit being openable to flow-through of the ambient atmospheric air and for contacting it with the sorbent material for an adsorption step,
wherein the adsorber structure comprises an array of individual adsorber elements, each adsorber element, at least one sorbent layer comprising at least one sorbent material, and at least one protective layer comprising a microporous material disposed around the support layer and the sorbent layer, where said sorbent material offers selective adsorption of CO₂ over other major non-condensable gases in air in the presence of moisture or water vapor, wherein the protective layer has greater hydrophobicity than the sorbent material, wherein the adsorber elements in the array are arranged essentially parallel to each other and spaced apart from each other, forming parallel fluid passages for flow-through of at least one of ambient atmospheric air and desorbing media,
at least one device for separating carbon dioxide from water.

9. The device according to claim 8, wherein the spacing width (b_{spacer}) is inclusively within the range of 0.4-5 mm,
or wherein the element length (L) is inclusively within the range of 100-3000 mm.

10. The device according to claim 8, wherein the element length (L) is given as a function of the spacing width (b_{spacer}), and as a function of the element thickness (bₑₗₑₘₑₙₜ) by the following equation:
$$L = \frac{{K}_{global} \cdot {b}_{spacer}^{2}}{( 1 + \frac{{b}_{element}}{{b}_{spacer}} )} ,$$
wherein K_{global} is inclusively within the range of 70-2500 mm⁻¹.

11. The device according to claim 8, wherein the adsorber elements comprise a central carrier layer and on both sides thereof at least one sorbent layer,
or wherein the adsorber structure comprises an array of individual adsorber elements, each adsorber element comprising a central porous carrier layer or porous support and on one or both sides thereof at least one porous and/or permeable sorbent layer,
or wherein the adsorber structure comprises an array of individual adsorber elements, each adsorber element comprising a central carrier or support layer and on both sides thereof at least one porous and/or permeable sorbent layer with chemically attached carbon dioxide capture moieties.

12. The device according to claim 8, wherein the adsorber elements in the array are arranged essentially parallel to each other and spaced apart by spacer elements from each other forming parallel fluid passages for flow-through of ambient atmospheric air and/or desorbing media, wherein the spacer elements comprise a sorbent material configured to facilitate adsorption and desorption through the spacer elements,
or wherein the spacing between the adsorber elements is inclusively within the range of 0.2-5 mm.

13. The device according to claim 8, wherein the flow speed of the ambient atmospheric air through the adsorber structure is inclusively within the range of 2-9 m/s,
or wherein the flow speed of the desorbing media through the adsorber structure is inclusively within the range of at least 0.2 m/s,
or wherein the flow speed of the ambient atmospheric air through or at the inlet into the adsorber structure is inclusively within the range of 4-7 m/s,
or wherein the flow speed of the desorbing media through the adsorber structure is inclusively within the range of 0.3-6 m/s.

14. The device according to claim 8, comprising means for directing the desorbing media in a desorbing media flow-through step (d) along a different flow direction than the flow direction of the flow-through direction of the ambient atmospheric air in the adsorption step (a).

15. The method according to claim 1 carried out for direct air capture or for recovery of carbon dioxide from ambient atmospheric air.

16. The method according to claim 2, wherein at least in step (d) the flow speed of the desorbing media through the adsorber structure is in the range of 0.3-1.0 m/s if the flow of the ambient atmospheric air in step (a) and the flow of the desorbing media in step (d) are essentially along the same flow path,
or wherein at least in step (d) the flow speed of the desorbing media through the adsorber structure is in the range of 1-6 m/s if the flow of the ambient atmospheric air in step (a) and the flow of the desorbing media is step (d) are along different flow path flows, or if the flow of desorbing media in step (d) is essentially orthogonal to that of the ambient atmospheric air in step (a).

17. The method according to claim 1, wherein in step (a) the specific flow rate of the ambient atmospheric air through the adsorber structure, as a function of the mass of the sorbent, is in the range of 100-7,000 m³/h/kg,
or wherein in step (a) the specific flow rate of the ambient atmospheric air through the adsorber structure, as a function of the volume of the sorbent, is in the range of 10,000-300,000 m³/h/m ³,
or wherein at least in step (d) the specific flow rate of the desorbing media through the adsorber structure, as a function of the mass of the sorbent, is in the range of 50-250 kg/h/kg,
or wherein at least in step (d) the specific flow rate of the desorbing media through the adsorber structure, as a function of the volume of the sorbent, is in the range of 500-10,000 kg/h/m ³.

18. The method according to claim 1, wherein the carbon dioxide capture fraction, defined as the percentage of carbon dioxide captured from the ambient atmospheric air in an adsorption step by the sorbent material is in the range of 30-60%,
or wherein the amount of carbon dioxide captured on the sorbent per gram sorbent is in the range of 0.1-1.8 mmol/g for an adsorption time span of at least 5 or at least 10 minutes,
or wherein the normalized amount of carbon dioxide captured on the sorbent per gram sorbent per hour is in the range of 1-6 mmol/g/h.

19. The method according to claim 1, wherein the adsorber structure comprises an array of individual adsorber elements, each adsorber element comprising a central carrier layer or porous support and on both sides thereof at least one porous and/or permeable sorbent layer with chemically attached carbon dioxide capture moieties, in the form of amine groups, wherein the porous sorbent layer is in the form of a woven or non-woven, fiber based structure,
wherein said carrier or porous support layer can be based on at least one of metal, polymer, carbon, carbon molecular sieve and graphene material.

20. The method according to claim 1, wherein the spacing (b_{spacer}) between the adsorber elements is in the range of 0.4-3 mm,
or wherein each adsorber element has the form of a plane with a thickness (bₑₗₑₘₑₙₜ) in the range of 0.2-0.5 mm.

21. The method according to claim 1, wherein said unit is evacuable to a vacuum pressure of 400 mbar(abs) or less, and wherein step (b) includes isolating said sorbent with adsorbed carbon dioxide in said unit from said flow-through while maintaining the temperature in the sorbent and then evacuating said unit to a pressure in the range of 20-400 mbar(abs), wherein in step (c) injecting a stream of saturated or superheated desorbing media is also inducing an increase in internal pressure of the reactor unit, and wherein step (e) includes bringing the sorbent material to ambient atmospheric pressure conditions and ambient atmospheric temperature conditions, and wherein after step (d) and before step (e) the following step is carried out:
(d1) ceasing the injection and, if used, circulation of desorbing media, and evacuation of the unit to pressure values between 20-500 mbar(abs), or in the range of 50-250 mbar(abs) in the unit, thereby causing evaporation of water from the sorbent and both drying and cooling the sorbent,
wherein step (e) is carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions,
or wherein said ambient atmospheric air in step (a) flows through said parallel fluid passages essentially along a first direction, and wherein said desorbing media in at least one or both of steps (c) and (d) flows essentially along that same first direction or a direction essentially opposite to said first direction,
or wherein said ambient atmospheric air in step (a) flows through said parallel fluid passages essentially along a first direction, and wherein said desorbing media at least one or both of steps (c) and (d) flows essentially along a direction orthogonal to said first direction through said parallel fluid passages.

22. The device according to claim 8 for carrying out a method for separating gaseous carbon dioxide from a gas mixture in the form of ambient air, containing said gaseous carbon dioxide as well as further gases different from gaseous carbon dioxide by cyclic adsorption/desorption using a sorbent material adsorbing said gaseous carbon dioxide,
said device comprising a desorbing media source;
at least one unit containing an adsorber structure with said sorbent material, the adsorber structure being heatable to a temperature of at least 60° C. for the desorption of at least said gaseous carbon dioxide and the unit being op enable to flow-through of the ambient atmospheric air and for contacting it with the sorbent material for an adsorption step, wherein the unit is evacuable to a vacuum pressure of 400 mbar(abs) or less,
wherein the adsorber structure comprises an array of individual adsorber elements, in the form of layers, each adsorber element, comprising at least one support layer, comprises at least one sorbent layer comprising or consisting of at least one sorbent material, where said sorbent material offers selective adsorption of CO₂ over other major non-condensable gases in air in the presence of moisture or water vapor, wherein the adsorber elements in the array are arranged essentially parallel to each other and spaced apart from each other, essentially equally spaced apart from each other, forming parallel fluid passages for flow-through of ambient atmospheric air and/or desorbing media.

23. The device according to claim 8, wherein the individual adsorber elements have an element length (L) along the flow-through direction of the ambient atmospheric air in an adsorption step (a), wherein the individual adsorber elements have an element thickness (bₑₗₑₘₑₙₜ) along a direction orthogonal to said flow-through direction, and wherein the spacing between the adsorber elements has a spacing width (b_{spacer}), and wherein further the spacing width (b_{spacer}) is in the range of 0.4-5 mm, and the element length (L) is in the range of 100-3000 mm.

24. The device according to claim 8, wherein the at least one device for separating carbon dioxide from water is a condenser.

25. The device according to claim 8, wherein at the gas outlet side of said device for separating carbon dioxide from water, there is at least one of, or both of a carbon dioxide concentration sensor and a gas flow sensor for controlling the desorption process.

26. The device according to claim 8, wherein the spacing width (b_{spacer}) is in the range of 0.5-3 mm,
or wherein the element length (L) is in the range of 200-2000 mm.

27. The device according to claim 8, wherein the element length (L) is given as a function of the spacing width (b_{spacer}), and as a function of the element thickness (bₑₗₑₘₑₙₜ) by the following equation:
$$L = \frac{{K}_{global} \cdot {b}_{spacer}^{2}}{( 1 + \frac{{b}_{element}}{{b}_{spacer}} )} ,$$
wherein K_{global} is in the range of 200-1000 mm⁻¹,
or wherein bₑₗₑₘₑₙₜ is in the range of 0.1-1 mm, or in the range of 0.1-0.5 mm
or wherein b_{spacer} is in the range of 0.4-5 mm, or 0.5-3 mm.

28. The device according to claim 8, wherein the adsorber elements comprise a central carrier layer and on both sides thereof at least one sorbent layer,
or wherein the adsorber structure comprises an array of individual adsorber elements, each adsorber element comprising a central porous carrier layer or porous support and on one or both sides thereof at least one porous and/or permeable sorbent layer, with chemically attached carbon dioxide capture moieties, in the form of amine groups, wherein the porous sorbent layer is in the form of a woven or non-woven, fiber based structure,
wherein said carrier or porous support layer can be based on at least one of metal, polymer, carbon, carbon molecular sieve and graphene material,
or wherein the adsorber structure comprises an array of individual adsorber elements, each adsorber element comprising a central carrier or support layer and on both sides thereof at least one porous and/or permeable sorbent layer with chemically attached carbon dioxide capture moieties, in the form of amine groups, wherein the porous sorbent layer can be in the form of a woven or non-woven, fiber based structure,
or wherein said support or carrier layer is based on at least one of metal, polymer, carbon, carbon molecular sieve and graphene material, and is porous.

29. The device according to claim 8, wherein the spacing between the adsorber elements is in the range of 0.5-3 mm, and wherein each adsorber element has the form of a plane with a thickness in the range of 0.2-0.5 mm.

30. The device according to claim 8, comprising means for directing the desorbing media in a desorbing media flow through step (d) along a different flow direction than the flow direction of the flowthrough direction of the ambient atmospheric air in the adsorption step (a), along a flow direction orthogonal to the flow-through direction of the ambient atmospheric air in the adsorption step (a),
wherein at least in a desorbing media flow through step (d) the flow speed of the desorbing media through the adsorber structure is in the range of 1-6 m/s if the flow of the gas mixture in step (a) and the flow of the desorbing media in step (d) are along different flow path flows, further if the flow of desorbing media in step (d) is essentially orthogonal to that of the gas mixture in step (a).
